(19) United States
(12) Patent Application Publication
(10) Pub. No.: US 2026/0194161 A1
(43) Pub. Date: Jul. 9, 2026

(54) Detectable Marker Tape For Horizontal Drilling And Boring Applications

(71) Applicant: EAS IP, LLC, Arvonia, VA (US)

(72) Inventors: Ryan C. DUNN, Charlottesville, VA (US); Joshua M. PARMAN, Palmyra, VA (US); Christopher W. MOORE, Charlottesville, VA (US)

(21) Appl. No.: 18/281,562

(22) PCT Filed: Mar. 11, 2021
(86) PCT No.: PCT/US21/22016

§ 371 Date: Sep. 11, 2023

(51) Int. Cl. F16L 1/11

(52) U.S. Cl. CPC F16L 1/11; F16L 2201/60

(57) ABSTRACT

A detectable marker tape is disclosed for locating buried infrastructure. The detectable marker tape comprises a strong, elongated, non-stretchable core material and at least one remote locating device contained within an envelope of protective material. This envelope encloses and protects the elongated, non-stretchable core material and remote locating device(s). The detectable marker tape is capable of being reliably emplaced during a conventional Horizontal Drilling Machine pullback operation, because it is the strong, elongated, non-stretchable core material which is fastened to the Horizontal Drilling Machine drill string for the pullback operation. The detectable marker tape also comprises any known type of remote locating device which will allow the marker tape to be detected [from the surface] once the detectable marker tape has been buried underground.

### SEQUENCE LISTING

Not Applicable.

### CROSS-REFERENCE TO RELATED APPLICATIONS

Not Applicable.

### FIELD OF THE INVENTION

The present invention relates generally to the field of Marker Tape designed to mark an underground infrastructure, e.g. a natural gas pipeline, petroleum pipeline, power line, communications line, water line, etc., etc. so as to protect it from damage by excavation machinery. More specifically, the invention relates to a type of marker tape which: can be easily emplaced; is detectable from the surface after emplacement; has a very strong elongated, non-stretchable core material and detectable components encapsulated within a protective envelope. Applicants call this inventive marker tape boretrace™ and it is specifically designed to be successfully emplaced using a typical Horizontal Directional Drilling operation.

### BACKGROUND OF THE INVENTION

Accurate determination of the location of underground infrastructure or utility is obviously an important goal in order to avoid damage to the infrastructure or utility during subsequent construction. It should be noted that wherever the word “infrastructure” is subsequently used in this application, it is to be understood that the words “utility” or “utilities” are to be considered synonymous with the word “infrastructure”. The words are used interchangeably and intended to mean the same thing(s). There have been many systems developed over the years to detect, locate and map ferrous and other metallic underground utilities. Most of these systems involve applying or inducing an alternating current in the metallic underground utility. The applied or induced alternating current produces magnetic fields which can then be sensed from the surface and used to map the underground utility. However, in recent years it has become common practice to use non-metallic [e.g., polymer] materials for underground utilities. For example, gas, water and sewer lines are increasingly being made from polymer(s). Conventional systems for locating a buried metallic utility do not work well [or at all] with a non-metallic utility.

However, there are a number of known methods for mapping from the surface the location of an underground non-metallic utility. Applicant's invention is a specific type of detectable marker tape designed to aid in the location of a buried non-metallic infrastructure and to be successfully emplaced using the pullback operation of a conventional Horizontal Directional Drilling machine.

### LOCATION FROM THE SURFACE OF UNDERGROUND UTILITIES

There are a number of ways currently known to map from the surface the location of a buried non-metallic utility.

### Tracer Wire Technology

Tracer Wire is a well-known device for locating a buried non-metallic utility. A metallic wire [the tracer wire] is buried in a known spatial relationship to the buried non-metallic utility. An AC current is then applied to or induced in the buried tracer wire. This AC current in the tracer wire will cause the tracer wire to generate magnetic fields which magnetic fields can then detected from the surface using known detector devices. These known detector devices can then locate the tracer wire and “map” the location of the tracer wire. Since the spatial relationship of the tracer wire to the non-metallic underground utility is known-mapping the location of the tracer wire essentially maps the location of the underground utility.

As noted above, tracer wire should be buried in a known spatial relationship to the underground utility. For example, the tracer wire may be buried a few inches, i.e., two in or more [5.1 cm or more] above the underground utility or a few inches, i.e., two in or more [5.1 cm or more] to one side or the other of the underground utility. The tracer wire may also be buried directly on top of the underground utility. The important thing is, whatever spatial relationship the tracer wire has with the underground utility, that spatial relationship must be known. At predetermined intervals along the length of the underground utility, the tracer wire is brought to the surface of the ground or to a manhole or other access port near the surface of the ground so that an electric current may be applied to the tracer wire. When it is desired to locate the underground utility, the tracer wire is accessed, and an AC current is applied to it at one end and another end of the tracer wire is grounded. This AC current flowing through the tracer wire generates a fluctuating magnetic signal which is broadcast from the tracer wire. This signal can be remotely detected and mapped from the ground surface using hand-held conventional magnetic locating devices [receivers]. Since the spatial relationship between the tracer wire and the underground utility is known, mapping the tracer wire essentially maps the underground utility.

Several companies sell this type of magnetic locating equipment. For example, the CL 300 Cable Locating Kit from Schonstedt Instrument Company contains a magnetic receiver such as the “Maggie” or the “GA-92XTd” or a similar receiver; a transmitter which can apply an AC current directly to a metallic underground utility and which can also induce an AC current using an inductive clamp, or by remote induction, and the various accessories necessary to map underground utilities or tracer wire.

Using the Schonstedt system, the transmitter can either be electrically connected directly to a metallic underground utility [or to a metallic tracer wire] to induce the desired magnetic fields. In addition, Schonstedt provides an inductive clamp which can be clamped about the underground utility [or the tracer wire] and the transmitter will then induce the desired magnetic fields in the metallic utility or the tracer wire without a direct electrical connection. Lastly, the transmitter has the capability to directly broadcast a varying magnetic field from the surface of the ground, which varying magnetic field will then induce the desired magnetic fields in the buried metallic underground utility or tracer wire. Obviously, this last option is more limited with regard to range and the direct electrical connection is the preferred operating mode. Under ideal conditions, the Schonstedt system can detect underground metallic utilities at depths up to 19 feet [or approximately 5.8 m].

FIG. 1 shows a conventional underground utility 12 with a tracer wire 14 emplaced directly above utility 12. Underground utility 12, in this case a pipe, is buried approximately 2.0 feet [approximately 0.61 m] beneath ground surface 10. As shown by X in FIG. 2, tracer wire 14 is buried approximately 2 to 5 inches [approximately 5.1-12.7 cm] above the top of underground utility 12 and directly over underground utility 12.

It is important that the tracer wire be properly treated to protect it from the underground environment. Broken tracer wire is essentially useless, and tracer wire may be broken in several ways. It may be broken during installation [i.e., burial] or it may be broken after burial. After burial, for example, the tracer wire insulation may break down in the soil and then corrosion of the exposed metallic portion of the wire can cause a break in the wire. It is also entirely possible, as will be discussed infra, that the tracer wire may be broken during installation and particularly if it is installed during a pullback operation using a Horizontal Directional Drilling machine. If any of these situations cause the tracer wire to be broken, it will be impossible to use the wire to map an underground utility. In addition, as one source¹ relates, the use of improper protective covering for a copper tracer wire can have disastrous results. If the locality specification for tracer wire only requires the contractor to “Install #12 solid copper wire with jacket” [as many localities do so specify] the contractor may well go to the nearest lumber yard or electrical wholesaler and purchase the cheapest #12 solid copper wire available. Often this will be THHN wire or “Thermoplastic, High-Heat-resistant Nylon coated wire. The nylon PVC coating on THHN wire will typically last for about two [2] years underground before it deteriorates and exposes the copper. Bare copper wire, over time, tends to return to its original state, that is, earth. This situation will obviously cause a loss of signal and make it much more difficult [or impossible] to use the tracer wire to locate and map an underground utility.

The tracer wire can be easily laid in the desired location with respect to the underground utility if the utility is installed using a trenching method. The tracer wire can also be laid using a Horizontal Directional Drilling system by affixing the tracer wire to the boring head at the same time as the boring ¹ “Do's and Don'ts of Tracer Wire Systems”, Michael Moore, downloaded from WaterWorld™ at http://www.waterworld.com/articles/2010/09/dos-and-donts-of-tracer-wire-systems.html in February, 2017. head is used for pulling back the underground utility. This is most often done when the underground utility is made from non-metallic materials and thus not easily locatable after burial by known locating and mapping techniques. In this circumstance, it is known to emplace multiple tracer wires along with the underground utility in the hope that one tracer wire, at least, will not break and thus provide a locating signal when needed. When the utility is laid by Horizontal Directional Drilling, the strength of the tracer wire becomes quite important since breakage during pull back is, obviously, a much more serious problem than breakage with a trench-laid underground utility. Since normal copper tracer wire does not have high tensile strength, it is sometimes desired to use copper-clad steel wire as tracer wire in boring operations. This construction gives much increased strength to the tracer wire with substantially the same conductivity for equivalent sized wires.

Conventional prior art tracer wire is shown in FIGS. 2 and 3. As shown in FIG. 2, conventional tracer wire 16 may comprise a solid conductive metallic core 18 [e.g., a solid copper core] covered by insulation 20. FIG. 3 shows the conventional tracer wire as a cross-section along arrow A of FIG. 2. A conventional copper-clad steel tracer wire 16′ is shown in FIG. 4. Wire 16′ comprises a solid steel wire core 18′ with a copper coating 22 covered with an insulation layer 20′. It is noted that steel core 18′ may also comprise a multi-stranded wire instead of a solid steel core.

### Marker Tape Technology

Another well-known method for locating underground utilities is the use of Marker Tape. Marker tape is a passive system which provides a warning of imminent excavation damage to underground infrastructure such as pipelines, buried power lines, buried communication lines and any other type of buried infrastructure. Currently, marker tape is the standard protective measure used in new installations of buried infrastructure. Burying marker tape, a passive visual indicator, directly above a buried infrastructure is easily done by infrastructure installation crews. It is normally laid directly over the buried infrastructure such that the marker tape will be struck first by excavation machinery working near the buried infrastructure. The idea is that, when the marker tape is struck by excavation equipment, portions of the marker tape will be pulled to the surface or at least to a position in the excavation trench where the portions may be seen so that excavation crews can be warned of the imminent danger to the buried infrastructure. Marker tape comes in a variety of widths and flexible materials. Some contain metallic components such as tracer wire or foil, the purpose of which is to aid in remotely locating—from the surface—the marker tape [and thus the infrastructure] after it has been installed [i.e., buried underground and above the infrastructure]. Some marker tapes are designed to stretch under the theory that when struck by excavation machinery [usually an excavator bucket], they can be pulled to or near the surface where they can be seen. Obviously, if pulled to the surface, it would be possible for the marker tape to be seen by the excavation crew but it might also be possible for the marker tape to be seen if pulled nearly to the surface. For example, if the marker tape was pulled up into an open trench [but still below the ground surface] it might be possible for the marker tape to be seen in the open trench by a spotter [the excavation crew member charged with keeping an eye on the trench and alerting the backhoe operator to stop digging if anything suspicious is spotted in the trench]. Thus the visible marker tape could alert the excavation crew to the presence of buried infrastructure.

One example of prior art marker tape is U.S. Pat. No. 3,633,533 issued in 1972 to Gordon H. Allen et al. [hereinafter Allen '533]. Allen '533 disclosed an early example of marker tape comprising a thin plastic film which may be made, for example, of polyethylene or polypropylene or polyvinylidene chloride [e.g. Saran™] or a fluorocarbon. As shown in FIG. 5 [taken from Allen '533], marker tape 25 may comprise a film 28 which may have a thickness of about 0.001 to 0.002 inch [or 2.54×10⁻³ cm to 5.08×10⁻³ cm]. Each side of film 28 will carry a more or less continuous metallic coating 30, 30′. The metallic coating 30, 30′ may, for example, be made of aluminum which may be deposited as a thin film, of the order of a thickness of 0.00005 to 0.0007 inch [or 1.27×10⁻⁴ cm to 1.778×10⁻³ cm] by conventional vacuum deposition techniques. On each of the outside surfaces of the metal-coated film 28 there is a protective coating or film 32, 32′ of synthetic plastic which may, again, be of polyethylene or polypropylene or polyvinylidene chloride [e.g. Saran™] or a fluorocarbon.

The finished marker tape 25 should have a color which contrasts with the color of the earth soil surrounding or adjacent to the buried infrastructure. To this end the film 32, 32′ may have a color such as red, green, yellow, or any suitable other color which would contrast to the color of the earth soil in which the buried infrastructure is emplaced. Alternatively, if the film 32, 32′ is transparent, then the color of the metallic coating 30, 30′ itself may serve the purpose of providing to the finished marker tape 25 with a color contrasting to that of the earth soil. Other procedures, which would be known to one of ordinary skill in this art, may also be used to provide the necessary contrasting color to marker tape 25.

Allen '533 also teaches a marker tape 25′ as shown in FIG. 6 [also taken from Allen '533] comprising two thin metallic layers 34, 34′ each of which may have a thickness in the range of about 0.0005 inch [or 1.27×10⁻³ cm], and which are firmly laminated together by a thin film 36 of a laminating adhesive which may be a catalyzed epoxy cement. A thin film 38, 38′ such as the film 32, 32′ shown in FIG. 5 is laminated to each outside surface of the metallic layers 34, 34′. The provision of a color to the finished marker tape 25′ [which color is selected to contrast with the color of the earth soil] can be effected in the same manner indicated in connection with the embodiment shown in FIG. 5.

Allen '533 also teaches a marker tape 25″ as shown in FIGS. 7 and 8 [also taken from Allen '533] comprising a colored polyethylene or other moisture and soil-resistant synthetic plastic tape 40 which has on its surface a tracer wire 42, for example, made of copper, nickel or a ferrous alloy, in the form of a zigzag arrangement laying in channel 44 cut into the upper surface of plastic tape 40.

Laminated to the upper surface of tape 40 is another tape 46 of colored polyethylene or synthetic plastic. A variant of this embodiment is initially to coat the metallic wire with a protective synthetic plastic or similar material, as by passing the metallic wire through a hot melt of such plastic or material, and then to bond said coated wire directly to the marker tape 25″ by a passage through heated rollers. This process is a form of heat sealing. It is obvious that there are other methods which can be used to make the Allen '533 marker tape 25″. For example, the layers 40 and 46 could be simultaneously extruded around wire 42 in an extrusion process. The purpose of tracer wire 42, is to enable the marker tape 25″ to be detected while buried underground using conventional techniques. It is noted that Allen '533 does not teach that his wire 42, is anything other than an electric conductor useful for locating his marker tape while it is still underground. There is absolutely no teaching in Allen '533 that this wire 42, might be a strong core material as provided in the applicants' invention. Tape 25″ is colored and has soil contrasting reflective stripes to aid in tape detection. Allen teaches that the tape will be color coded in the accepted coding for the type of underground infrastructure or utility line being protected. The uniform color code generally accepted in the industry to identify underground facilities is as follows: Red—electric power lines; Yellow—gas, oil or steam lines; Orange—telephone, police and fire communications and cable television; Blue—water lines; and Green—sewer lines.

The purpose of the metallic foil in marker tapes 25 and 25′ is to permit the marker tapes to be detected using known techniques after the marker tape is buried underground. As noted above, the purpose of the metallic wire 42 in marker tape 25″ is also to permit the marker tape to be detected using conventional techniques while buried. No other purpose is even so much as hinted at in the Allen '533 disclosure. It is noted that Allen '533 does not provide thickness dimensions for his tape 25″; however, it seems conservative to assume, absent any disclosure to the contrary, that tape 25″ is either the same thickness as tape 25, 25′ or of a very similar thickness. In effect, metallic wire 42 is functioning as tracer wire in marker tape 25″.

Allen, in U.S. Pat. No. 4,623,282 [hereinafter “Allen '282”] is concerned with keeping the indicia and coloring legible on the buried tapes. It was found that the cautionary printing on the exterior tape surfaces of the previous Allen marker tapes was vulnerable to being removed by erasure, rubbing off, chemical activity under the ground by hydrocarbons, and by underground electrolysis. Thus, after a period of time, the cautionary printing disappears from his previous marker tapes due to scratching or rubbing off, and also due to natural causes from the effects of hydrocarbons or petroleum present under the ground and this renders the supplied cautionary printing indicia useless as a means of identifying the type of utility element supposedly being protected. As shown in FIG. 9 [taken from Allen '282], volume of soil 50 which has a soil surface 52 contains a buried pipe or other buried infrastructure 54 with marker tape 56 buried a few feet above pipe 54. As shown in FIGS. 10 and 11 [also taken from Allen '282] a frangible marker tape 56 is provided which carries cautionary printed indicia 58 with color coded indicia stripes 60 and contrasting color coded stripes 62. The stripes 60 may indicate the type of buried facility using the above-noted uniform color code. However, as Allen '282 notes the soil color may make these colored stripes hard to see.

Allen '282 provides a contrasting color coding with stripes 62 to make marker tape 56 easy to see. It is possible and even likely that the coded tape color corresponding to the associated utility line or element of construction does not form a contrast with the surrounding earth soil sufficient to reliably caution one digging in the soil. For example, when a red colored locating tape associated with electric power lines, etc. is placed in red-colored soil such as sandstone or reddish clay, the desired contrast between the locating tape color and the surrounding soil is not present. Similarly, orange coded tapes often do not provide sufficient contrast in desert soils, and green coded and blue coded tapes are often problems in heavily forested or shaded areas. In such instances, the utility line may be damaged before one views the cautionary locating tape.

Cautionary printed indicia 58 is repeated on the tape 56 so that the cautionary printed indicia extends the full length of tape 56 which tape extends the full length of utility line 54. Marker tape 56 also included cautionary coded indicia 60 in the form of colored stripes extending across marker tape 56. In the illustrated example of FIGS. 9-11, line 54 is assumed to be a water line, therefore according to the uniform industry code, cautionary stripes 60 would be blue stripes. Tape 56 further includes cautionary contrast stripes 62 extending across the tape and forming a contrast in color with color coded stripes 60 as well as with the color of the surrounding soil 50. Contrast stripes 62 provide a high visibility and high light reflective characteristic to marker tape 56 so that the tape can readily be seen when placed in earth soils whose color is close to the color of color coded stripes 60. As shown in FIG. 11, cautionary indicia 58 is reverse printed on the underside of clear polyester plastic film 64 thus protecting the cautionary indicia from scratching or rubbing off. A flexible metal foil 66 [for example Aluminum] with a highly reflective surface is provided with color coded stripes 60 so that highly visible and reflective stripes 62 are formed on the surface of Aluminum foil 66. The printed surface of foil 66 is then placed adjacent the printed surface of clear plastic film 64 and the two are bonded together with adhesive 68. To protect the bottom of Aluminum foil layer 66 another clear polyester film 70 is bonded to the undersurface of foil 66 by adhesive 72.

Allen '282 discloses what he means by a “frangible” marker tape as follows: the strength of the locating tape is such that in conventional digging, in connection with excavating, laying utility lines or elements of construction or cutting into the earth for any other reason by means of mechanical or similar digging or excavating equipment such as backhoes or trenchers, if the locating tape is engaged and pulled upon by such equipment, the teeth or the like on the equipment will sheer, sever or break the tape and the tape will be ripped from the earth and pulled loose for several feet along its length.

Unfortunately, even the improved Allen '282 marker tape tends to be quickly severed by the excavator bucket and little visible material is left in the thus exposed trench to be seen by an observer. The material severed by the bucket is contained within the soil in the bucket and is also not visible to an observer or the equipment operator.

Southworth Jr., in U.S. Pat. No. 3,568,626 [hereinafter “Southworth '626”], discloses an indicator assembly [i.e. marker tape] which is designed to be pulled from the soil when contacted by the bucket or scoop of excavation equipment. FIGS. 12 and13 [taken from Southworth '626] shows a volume of earth 80 containing a buried pipeline 82 or other buried infrastructure which is to be protected from excavation damage by marker tapes 84 and 84′ which are buried respectively a few feet under the surface of earth 80 and a few feet above pipe 82. Marker tapes 84 and 84′ are identical and shown in more detail in FIG. 14 [also taken from Southworth '626].

As shown in FIG. 14, illustrating marker tape 84′ generally along section D-D, marker tape 84′ [which is identical to marker tape 84] is an elongated extensible vinyl sheet 86 folded about two nylon cords 88 and 90 of approximately one-quarter inch [or approximately 0.635 cm] in diameter. The vinyl may, for example, be polyethylene and have the ability to stretch to up to eight times its length before breaking. The nylon cords are preferable stretchable up to three or four times their length. Such materials are described in “The Handbook of Chemistry and Physics,” 41st Edition, published by Chemical Rubber Publishing Company of Cleveland, Ohio. The cords 88 and 90 fit into the longitudinal folds in the sheet 86 so as to form elongated ridges at the edges of the marker tapes 84, 84′. A suitable adhesive on one face of the sheet material 86 secures the cords 88 and 90 in place and holds the edges of the sheet 86 against the central portion of the sheet 86 so as to form the substantially unitary assembly of FIG. 14. When the marker tapes 84, 84′ is buried above a utility line, an operator of automatic excavating equipment, a plow, or a laborer with a shovel, upon hitting the marker tape 84, 84′, starts to bring it up with his implement. In doing so, he can notice the resistance afforded by the marker tape.

The latter, in response to the effort of the implement, yields elastically so that a portion of it becomes visible above the portion of the soil being dug. A suitable legend 92 at multiple locations on the surface of the marker tape then apprises the operator of the existence of the utility. The legend 92 in FIG. 14 also includes an indication that the marker tape 84, 84′ has applied thereto magnetic coding signals 94 and radioactive coding signals 96. It instructs the operator that the path of the utility line may be followed by sensing the successive coding signals along its path with suitable sensing equipment above ground.

Southworth '626 teaches that the marker tapes 84, 84′ instead of having nylon cords 88, 90 sandwiched only at the edges, may have similar cords 88′, 90′ sandwiched throughout the marker tape as shown in FIG. 15. These cords 88′, 90′ may be in a regular or random pattern. Southworth '626 also teaches that these cords 88′, 90′ may constitute fiberglass or steel strands.

Southworth '626 teaches that his ribbon cords 88, 88′ and 90, 90′ are strong enough to cause the ribbon to be pulled to the surface when encountered by excavation machinery. However, Evett, U.S. Pat. No. 3,908,582 [hereinafter Evett '582] indicates otherwise. Evett '582 teaches that the Southworth tape will have portions of the tape adjacent the trench dug by the excavation equipment sheer before being pulled from highly compacted soil—thus preventing the Southworth tape from being stretched to a readily observable longitudinal extent. The Southworth '582 tape-- while intended to be infrangible and of such strength and sufficiently stretchable that a substantial portion of the Southworth tape will be pulled by the excavation machinery to a more observable position-- will actually sheer off in the ground. In other words, the prior art recognizes and teaches that Southworth '626 does not provide a marker tape with a core material that is capable of being consistently pulled out of the ground, without breaking, while also, consistently, bringing some, at least, of the remainder of the marker tape to the surface.

### Horizontal Directional Drilling Technology

A very common method for laying underground utilities is Horizontal Directional Drilling using a horizontal directional drilling machine such as is shown in Geldner, U.S. Pat. No. 5,803,189 [hereinafter “Geldner '189”]. As shown in FIG. 16 and disclosed in Geldner '189, the conventional Horizontal Directional Drilling machine 100 comprises a movable carriage 101 mounted on a tracked base 102 with a longitudinal boom 103 mounted on carriage 101. Drill string 104 comprises a series of connected, somewhat flexible segments threaded together with a conventional drill bit 106 mounted at the end thereof. The drill string segments are usually approximately 10 feet to 20 feet long and often made from hollow steel tubing. The steel tubing comprising the individual segments of drill string 104 is fairly rigid; however, when connected in a long string, they are somewhat flexible in a manner similar to conventional oil well drill string pipe. It is in this manner that the borehole can be curved using known drilling techniques. Multiple individual segments of drill string 104 [which segments are not shown in the drawings] are provided on or near directional boring machine 100 for use in drilling the borehole. A first end of a drill string segment is attached to drill spindle 108. The opposite end of the drill string segment has drill bit 106 attached thereto. Drill spindle 108 is mounted on boom 103 for forward and reverse movement along longitudinal boom 103. Drill spindle 108 is also capable of rotating drill string 104. Boom 103 is angled relative to surface 110 such that drill the string segment and thus drill bit 106 can be rotated and drilled into the soil at an angle ranging from about 5°to 25°. Drill spindle 108 includes a rotating spindle head 105, generally driven by hydraulic motor 107, to which one or more elongated drill string segments are detachably connected.

Conventional Horizontal Directional Drilling machines operate by connecting one end of a first drill string segment to rotating spindle head 105 of the drill spindle 108 and connecting drill bit 106 to the opposite or outer end of the drill string segment. With drill spindle 108 in a retracted position on boom 103, spindle rotation begins, and the drill spindle 108 is advanced down boom 103 resulting in the drilling of a bore. When drill spindle 108 reaches the outer boom end, drill string 104 is detached from the rotating spindle head 105 and drill spindle 108 is retracted to its original position. One end of a second drill stem is then mounted to rotating spindle head 105 with its opposite end connected to the existing drill stem. The drilling process then continues until drill spindle 108 again reaches the end of boom 103, and the process is repeated. In this manner a borehole is generated in which a utility line may be emplaced using a conventional pullback operation.

When drilling underground boreholes using a conventional Horizontal Directional Drilling machine such as that described by Geldner '189, the ultimate target of the borehole is often a target pit 108 dug into the soil. When drilling the borehole over significant distances it is known to provide a midway target pit 109 to aid in locating the borehole at the correct position such that any necessary drilling corrections may be made. Sometimes the target pit 108 is dispensed with and the drill stem and drill bit are simply brought back to and above the soil surface 110.

Groebner et al [U.S. Pat. No. 7,367,748: hereinafter “Groebner '748”] teaches that it is known to emplace a non-metallic pipeline and tracer wire at the same time using a Horizontal Directional Drilling machine. Since, by their very nature, non-metallic pipelines are rather difficult [perhaps impossible] to locate from the surface using conventional locating techniques, tracer wire is normally emplaced on or near the non-metallic pipeline so that the tracer wire may be located from the surface using conventional remote locating techniques. FIG. 17 [which is essentially taken from Groebner '748] illustrates the emplacement of a copper-clad steel wire with a non-metallic utility line during a conventional pullback operation. Groebner '748 emplaces a copper-clad steel wire 120 [described above and shown as 16′ in FIG. 4] in borehole 122 as shown in FIG. 17. The walls of borehole 122 are shown in dashed lines in FIG. 17 for clarity. In addition, section 124 of borehole 122 is enlarged in the center of FIG. 17 in order to better illustrate the pullback operation. A conventional Horizontal Directional Drilling machine 126 [such as that described by Geldner '189] is emplaced on the soil surface 130 and bores a borehole 122 underneath soil surface 130 in a known manner using a series of connected drill stems 132 carrying a drill bit [not shown in FIG. 17]. The proximal side 134 of the borehole 122 is located near directional drilling machine 126 and the distal side 136 of borehole 122 is at a location remote from directional drilling machine 126. In this instance borehole 122 was returned to the surface to accomplish the pull back operation. After the drill bit and drill stem were driven out of the soil surface at distal location 136, the drill bit was removed from connected drill stems 132 and a non-metallic utility 138 is attached to the end of the drill stem where the drill bit formerly was. A reamer 140 is attached to the drill stem. Coupler 142 is designed to removably secure one end of underground utility 138 attached to reamer 140 by connecting joint 144. Underground utility 138 is shown in a dotted line at the distal end of FIG. 17 for clarity but is show as interconnected segments 138′ in the enlarged portion 124 of FIG. 17. Once underground utility 138 has been attached to the end of the drill stem a copper-clad tracer wire 120 is attached to the forward section of coupler 142. This is normally done by tying the end of wire 120 in a knot around the smaller diameter front section of coupler 142. The drill stem is them withdrawn from the distal side 136 and pulls the wire 120 and the underground utility 138 back through borehole 122 to the proximal side 134 of borehole 122. It should be noted that, with some horizontal directional drilling machines it is not necessary to remove the drill bit to perform a pullback operation. A tow head or duct puller may be secured to the drill bit by means of an adapter which adapter attaches directly to the drill bit. Since the tow head or duct puller is adapted to receive the underground utility and secure it for the pullback operation, it is not necessary to remove the drill bit nor is it necessary to attach a reamer. This type of pullback mechanism is shown in FIG. 4 of Melsheimer et al., U.S. Pat. No. 9,719,344 B2 [hereinafter Melsheimer '344]. In this figure a tow head or duct puller 126 is shown attached to drill bit 104 by adapter 124 which is bolted to drill bit 104 by bolt 123. It is thus not always necessary to remove drill bit 104 from the drill string to attach an underground utility such as conduit 127. Nor is it necessary to use a reamer as Groebner '748 described supra does [all italicized reference numbers in this paragraph refer to reference numerals shown in FIG. 4 of Melsheimer '344].

At least, in a perfect world, the pullback operation would work this way—with the single copper-clad steel wire coming through the pullback operation with no problems. Unfortunately, even using copper-clad steel wire, it is quite normal to break the tracer wire 120 during the pullback operation. This leads to multiple tracer wires being tied around the front section of coupler 142 for the pullback operation in the hopes that at least one of them will not break during the pullback operation. A simple explanation exists. The walls of the borehole are often lined with jagged bits of rock which can [and often do] cause damage to the tracer wire. As can be seen from the enlarged area 124 in FIG. 17, tracer wire 120 is carried on the outer portions of attached segments 138′ of the underground utility. This permits any obstruction sticking out of the borehole wall to impinge upon tracer wire 120. Obviously, a sharp rock edge can easily cut the insulation of tracer wire 120 or even break the wire altogether. It should be noted that a cut or nick in the insulation which exposes the copper cladding on a copper-clad steel wire, or which exposes the copper core on a conventional copper tracer wire will also cause damage. The damaged insulation will, over time, deteriorate and ultimately expose the copper wire or copper-clad wire to the earth. Copper exposed to earth soon returns to its natural state, that is—earth. It may take a year or two, but exposed copper will not last long in the soil. So—even if tracer wire 120 is not actually broken during the pullback operation—damage can still occur which will cause the tracer wire to soon become worthless for its intended purpose.

### Buried Object Locator Technology

It is very convenient to be able to locate buried infrastructure from the surface before digging and finding the buried infrastructure the hard way—after the excavation equipment has damaged the buried infrastructure. It is also much safer to locate the buried infrastructure from the surface before digging. A number of fatal accidents occur every year when buried natural gas, petrochemical pipelines, or power lines are unknowingly damaged by excavation equipment. Several different technologies exist which will permit an object buried in soil to be located or mapped from the soil surface. As noted supra simple tracer wire when buried can be detected and mapped from the surface using known detectors such as the “Maggie” or the “GA-92XTd” magnetic locating receivers from Schonstedt Instrument Company. If the tracer wire is emplaced in a known spatial relationship over a buried utility, then mapping the tracer wire will also map the utility. Metallic foils can be incorporated within conventional marker tape to permit the buried marker tape to be detected and mapped from the surface with known detection devices. This is shown by Allen patents discussed supra. It is also known to incorporate simple tracer wire into marker tape in order to permit the buried marker tape to be located from the surface with conventional locating and detecting devices. Magnetic means can also be incorporated within the marker tape to permit location from the surface as shown in the Southworth′ 626 patent discussed supra. Southworth '626 also discloses that radioactive material may be utilized in the marker tape to permit its location underground.

### RF Markers

Radio Frequency markers [RF markers] are passive devices which are normally used for location purposes only and do not support either unidirectional or bidirectional data transfer between the RF marker and the detection device. They contain a tuned electronic circuit comprising a coupled inductor and capacitor and are designed to resonate when irradiated with an RF electromagnetic signal of a particular frequency. RF markers usually do not have a power supply and must derive the energy used to operate from an external source. When irradiated with an RF electromagnetic signal, the RF marker electronic circuit stores electromagnetic energy. When the incoming radiated RF electromagnetic signal is stopped, the RF marker electronic circuit will use the stored energy to rebroadcast the signal at the same frequency as the applied RF electromagnetic signal with an exponentially decaying amplitude. This rebroadcast signal is detected by the locator device and can be used to locate and map the buried RF marker. Even though RF markers are passive and do not support data transfer, it is still possible to use RF markers in such a way that they will provide a rudimentary means of communication between the buried RF marker device and the surface locator. By designing the RF marker to resonate at a particular frequency, and by associating that frequency with a particular type of buried infrastructure [power cable, natural gas pipeline, water pipeline, etc., etc.,] a locator operating at the assigned frequency will only detect an RF marker with the designated frequency which has already been assigned to a particular type of utility. As shown supra, it is known and conventional in this art to have marker tape and RF markers typically assigned color codes according to what type of utility they mark. For example, gas-line markers are yellow; telephone cable markers are orange; wastewater markers are green; water line markers are blue; power supply markers are red. In similar manner, inductive markers are frequently coded by tuning the coil to a particular frequency to represent a particular type of utility. The traditional frequencies are: 83.0 kHz for gas utilities; 101.4 kHz for telecom utilities; 121.6 kHz for wastewater; 145.7 kHz for water utilities; and 169.8 kHz for power utilities. A technician will use a detector tuned to the frequency for the desired utility. For example, if a technician is searching for a gas line, he must use a locator tuned to 83.0 kHz. That locator will activate only inductive markers also tuned to that frequency. Thus, by using RF markers tuned to the resonant frequency associated with the utility which is being marked, it is possible for the passive RF marker to “inform” the locator of what type of utility has been located.

### RFID Markers

Radio Frequency identification devices [RFID devices] such as those disclosed in Cardullo et al. U.S. Pat. No. 3,713,148 [issued 23 Jan. 1973] are designed to permit both location and identification of a buried utility. When using a buried RFID device as an infrastructure marker, a base station or surface locator apparatus transmits an “interrogation” electromagnetic signal to the buried RFID device. The buried RFID device then responds with an “answerback” signal. The buried RFID marker includes a changeable or writable memory and means responsive to the transmitted interrogation electromagnetic signal for processing the signal and for selectively writing data into or reading data out from the RFID device memory. The buried RFID device then transmits the answerback signal from the data read-out of its changeable or writable memory. This signal is received and interpreted by the base station or surface locator apparatus. RFID devices normally support both unidirectional and bidirectional data transfer. In other words, the buried RFID device can not only inform the surface locator what type of buried infrastructure it is “protecting” but other information may also be transmitted to the surface locator. In addition, the surface locator can transmit data to the buried RFID device. RFID markers are similar to RF markers in that they both have an inductor-capacitor circuit which responds to a radiated electromagnetic signal from a surface locator device; however, as noted supra, RFID markers have additional electronic components and can perform other functions than merely sending a RF signal to inform of their presence. RFID markers may be semi-passive-that is they have dedicated power supplies which are only turned on when irradiated by a locator RF electromagnetic signal which power supplies may also be augmented by energy transferred by this RF signal. They may also be active devices which have dedicated power supplies which are on all the time. It is obvious that the extra electronics and/or power supplies associated with RFID markers means that they are considerably more expensive than RF markers and also less rugged.

RF and RFID devices can be passive, semi passive or Active. Passive devices have no internal power source so all power must be derived from the incoming RF electromagnetic signal using inductive coupling. Semi Passive devices have an internal power source which is only active when interrogated by the incoming RF electromagnetic signal [and can be augmented by the incoming RF electromagnetic signal]. Lastly, active devices have a dedicated internal power source.

### Magnetomechanical Markers

It is also possible to mark buried infrastructure using a magnetomechanical marker. Magnetomechanical markers are passive devices which provide a low cost and very rugged alternative to traditional RF markers. Doany et al. U.S. Pat. No. 9,638,882, issued on 2 May 2017, [hereinafter Doany '822] discloses magnetomechanical markers which can be used to mark a buried utility. FIG. 18 [taken from Doany '822] shows an exploded view of a typical magnetomechanical marker 150. Marker 150 comprises a housing 152, resonator pieces 154, a cover 156 over resonator pieces 154 and a magnetic bias layer 158 disposed between cover 156 and housing cover 159. Resonator pieces 154 are made from a ferromagnetic material which has magnetostrictive properties. This means that resonator pieces 154 can deform when exposed to a magnetic field. For example, rapidly alternating magnetostriction causes the iron cores of transformers to hum or buzz. In this example, a magnetic bias layer 158 is emplaced to bias resonator pieces 154. Magnetostrictive marker 150 resonates at its characteristic frequency when interrogated with an alternating magnetic field tuned to this frequency.

Energy is stored in marker 150 during this interrogation period in the form of both magnetic and mechanical energy. The stored mechanical energy is manifested as vibrations in resonator pieces 154.

When the interrogation electromagnetic signal is removed, resonator pieces 154 continue to vibrate and release significant alternating magnetic energy at the resonator resonant frequency. This alternating magnetic energy can be detected by a suitable surface locator. Housing 152 and housing cover 159 must be strong enough to ensure that the housing can maintain its shape or spacing around resonator pieces 154, and must allow sufficient room for resonator pieces 154 to resonate or vibrate. It is possible to use a single resonator piece, two resonator pieces [as shown] or three or more resonator pieces, as desired. In addition, resonator pieces 154 can be designed to resonate at any desired frequency depending primarily upon their length, the strength or the magnetic bias field [generated by magnetic bias layer 158], the density of the resonator material and the Young's modulus of the material used to make resonator pieces 154.

### SUMMARY OF THE INVENTION

Applicants have discovered that conventional tracer wire and any type of known remote locator device can be emplaced quite reliably in a conventional Horizontal Drilling Machine pullback operation if the tracer wire and/or locator devices are incorporated into applicants'novel marker tape. This marker tape [which applicants call boretrace™] comprises a strong, elongated, non-stretchable, core material and a conventional tracer wire and/or any other type of remote locator device(s) with all of these components encapsulated within a protective envelope. The protective envelope can be made from any type of material which is resistant to the environment found underneath the soil surface; however, the preferred envelope is made from protective thermoplastic materials well-known in marker tape technology as will be explained infra. The protective envelope can be formed from a single strip of thermoplastic material with the elongated, non-stretchable, core material and the remote locator device(s) being placed on one surface thereof. The strip can then be folded about the elongated, non-stretchable, core material and the remote locator device(s) and sealed in order to encapsulate the elongated, non-stretchable, core material and remote locator device(s). The protective envelope could also be made from two strips of thermoplastic material fastened together with the elongated, non-stretchable, core material and remote locator device(s) emplaced between the two strips and with at least the edges of the strips being sealed together to form the protective envelope. It is also possible to extrude the protective envelope about the elongated, non-stretchable, core material and remote locator device(s). No matter how the protective envelope is formed, it is desirable that the elongated, non-stretchable, core material and the remote locator device(s) be firmly secured to at least one inside surface of the protective envelope. When any material involved with the inventive marker tape has to be joined to or sealed to or secured to another material, these materials are joined to, sealed to or secured to each other by means of a lamination process, by heat sealing, by application of an adhesive, by ultrasonic welding or by any other suitable joining process.

When tracer wire is the desired remote locator device, it is possible to use bare copper wire as the tracer wire because of the insulative and protective nature of the protective envelope. In addition, because of the added protection for the tracer wire given by the protective envelope, it is possible to use lower tensile strength copper tracer wire which has better corrosion resistance and conductivity than the higher tensile strength copper-clad steel tracer wire currently used to mark utilities emplaced by Horizontal Drilling Machine pullback operations. The improved corrosion resistance of solid copper tracer wire is an important feature to many utility companies to ensure the wire is locatable for as long as possible. Of course, copper wire [solid or stranded] has better conductivity than copper-clad steel tracer wire and will work better for marking and locating the underground infrastructure.

Applicants'inventive marker tape can also utilize larger remote locator devices such as the relatively new magnetomechanical remote locator devices described supra. These magnetomechanical remote locator devices cannot be emplaced inside a flexible rope as conventional RF and RFID markers can because they would be damaged or broken when the rope stretched or was bent. Instead of tying one or more pieces of copper-clad steel tracer wire 120 to the front end of coupler 142 as discussed supra [and shown in FIG. 17] and pulling tracer wire 120 back through borehole 122 along with utility 138, it is the strong, elongated, non-stretchable, core material of applicants'inventive marker tape which is tied to coupler 142. The strong, elongated, non-stretchable, core material thus absorbs the stress and strains of the pullback operation and transmits these to the marker tape which is emplaced with the utility. The tracer wire or other locator components are protected from damage during the pullback operation by the thermoplastic sheets. The strong, elongated, non-stretchable, core material may comprise polyester or aramid fibers or any other suitable type of material.

### BRIEF DESCRIPTION OF THE DRAWINGS

FIG. 1 shows an underground utility protected by a conventional prior art tracer wire.

FIG. 2 shows a conventional prior art copper tracer wire.

FIG. 3 shows a cross-section of the tracer wire of FIG. 2 along the direction of arrow A of FIG. 2.

FIG. 4 shows a conventional prior art copper-clad steel tracer wire.

FIG. 5 shows a first embodiment of conventional marker tape after Allen, U.S. Pat. No. 3,633,533.

FIG. 6 shows a second embodiment of conventional marker tape after Allen, U.S. Pat. No. 3,633,533.

FIG. 7 shows a plan view of a third embodiment of conventional marker tape after Allen, U.S. Pat. No. 3,633,533.

FIG. 8 shows a cross-sectional view of the embodiment of FIG. 7 along the plane A′-A′ of FIG. 7.

FIG. 9 shows a conventional marker tape as shown by Allen U.S. Pat. No. 4,623,282 protecting an underground pipeline.

FIG. 10 shows a plan view of the marker tape being used in FIG. 9 taken from Allen U.S. Pat. No. 4,623,282.

FIG. 11 shows a cross-sectional view along plane B-B of FIG. 10 also taken from Allen U.S. Pat. No. 4,623,282.

FIG. 12 shows a conventional marker tape protecting an underground pipeline after Southworth, Jr. U.S. Pat. No. 3,568,626.

FIG. 13 shows a cross-sectional view along plane C-C of FIG. 12.

FIG. 14 shows a view of the marker tape being used in FIG. 13 along the general view represented by plane D-D of FIG. 12 taken from Southworth, Jr. U.S. Pat. No. 3,568,626.

FIG. 15 shows a plan view of a second embodiment of marker tape taken from Southworth, Jr. U.S. Pat. No. 3,568,626.

FIG. 16 shows a conventional Horizontal Directional Drilling Machine drilling operation after Geldner, U.S. Pat. No. 5,803,189.

FIG. 17 shows a conventional Horizontal Directional Drilling Machine pullback operation after Groebner et al, U.S. Pat. No. 7,367,748.

FIG. 18 shows a known Magnetomechanical marker after Doany et al, U.S. Pat. No. 9,638,822.

FIG. 19 shows a strip and some of the common features of a strip as defined by Applicants.

FIG. 20 shows a strip and additional common features of same.

FIG. 21 shows a side view of a portion of the strip of FIG. 20 taken along arrow E of FIG. 20.

FIG. 22 shows a bottom view of the strip of FIG. 20 taken along arrow F in FIG. 20.

FIG. 23 shows one method of forming a protective envelope about the elongated, non-stretchable core material and a remote locator device using strips of protective material.

FIG. 24 shows the assembled marker tape using the method of envelope assembly illustrated in FIG. 23.

FIG. 25 shows an exploded view of a first embodiment of the inventive marker tape.

FIG. 26 shows an exploded view of a second embodiment of the inventive marker tape.

FIG. 27 shows a cross-sectional side view of the marker tape of FIG. 26 after assembly.

FIG. 28 shows an exploded view of a third embodiment of the inventive marker tape.

FIG. 29 shows an exploded view of a fourth embodiment of the inventive marker tape.

FIG. 30 shows an assembled view of the third embodiment of the inventive marker tape.

FIG. 31 shows a longitudinal cross-section of FIG. 30.

FIG. 32 shows a view of the marker tape according to the invention being installed with a non-metallic utility during a pullback operation.

FIG. 33 shows an exploded view of the marker tape according to the invention using magnetomechanical markers.

FIG. 34 shows a marker tape containing elongated, non-stretchable core material and tracer wire with the protective envelope as a strip in a flat configuration ready to be folded about the strip centerline to form the protective envelope.

FIG. 35 illustrates the marker tape shown in FIG. 34 after the strip has been partially folded about the strip center line.

FIG. 36 illustrates the marker tape shown in FIG. 34 after the strip has been partially folded about the strip center line but with the folding process shown further along than it is shown in FIG. 35.

FIG. 37 shows the marker tape shown in FIG. 34 with the strip almost completely folded.

FIG. 38 shows the marker tape shown in FIG. 34 with the strip completely folded.

FIG. 39 illustrates one method for making the marker tape shown in FIG. 25.

FIG. 40 illustrates one method for making the marker tape shown in FIGS. 26, 27, 28 and 33.

FIG. 41 illustrates another method for taking up the marker tape made in FIG. 40.

FIG. 42 illustrates another method for making the inventive marker tape.

FIG. 43 is a blown-up section of portion Y1 of FIG. 42.

FIG. 44 is a blown-up section of portion Y2 of FIG. 42.

FIG. 45 shows a rope-like elongated, non-stretchable core material with remote markers integrated within the body of the rope-like elongated, non-stretchable core material.

FIG. 46 shows a rope-like elongated, non-stretchable core material with tracer wire integrated within the body of the rope-like elongated core material.

FIG. 47 shows an elongated, non-stretchable core material comprising a ribbon with remote markers integrated within the elongated, non-stretchable core material.

FIG. 48 shows a prior art example of a polyester fabric pull tape with wire woven therein.

FIG. 49 shows a combined, elongated, non-stretchable core material, tracer wire unit usable as core material in applicants'inventive marker tape.

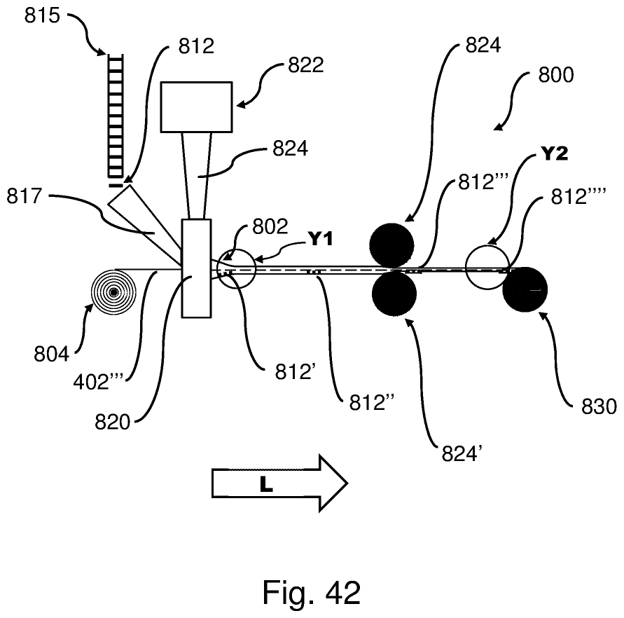

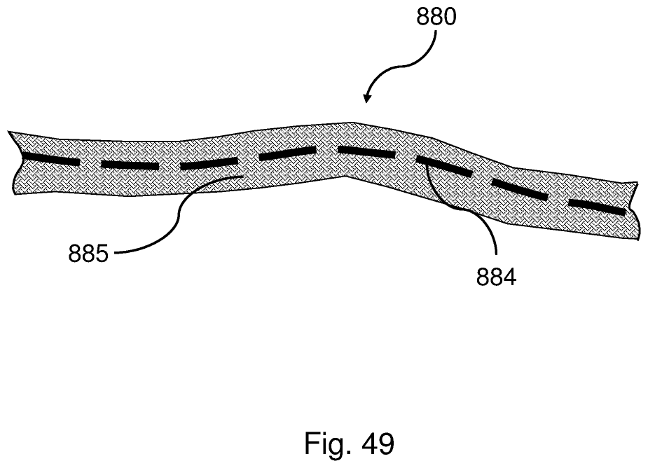

The accompanying drawings are shown to illustrate various embodiments of the present invention. It is to be understood that these embodiments may be utilized, and structural changes may be made, without departing from the scope of the present invention. The figures are not drawn to scale and no conclusions can be drawn from the relative sizes of components illustrated in the figures. For example, the actual thickness of the thermoplastic materials used to form the protective envelopes in the preferred embodiments of the invention is approximately 0.001 in-0.005 in [or approximately 0.00254 cm-0.0127 cm]. The actual thickness of the elongated, non-stretchable, core material used in the inventive marker tape is often approximately 1/16 inch [or approximately 0.16 cm]. Because of limitations in drafting black and white drawings, the thermoplastic materials and the elongated, non-stretchable, core material are often shown as being of approximately the same thickness. Obviously, this is simply not the case—but given the limitations of the required drawings, it is essentially impossible to accurately illustrate the relative thickness. This is one reason applicants point out that the figures are not drawn to scale. Similar reference numerals are often used in different figures to refer to similar components. For example, the elongated core material in one embodiment of the invention may be referred to by the reference numeral 302. Other embodiments of the invention may use reference numerals like 302′, 402, 402′ or 502 to designate the elongated core material in these embodiments. However, it will be understood that the use of a reference numeral to refer to a component in a given figure is not intended to limit the component in another figure labeled with a similar reference numeral. It is also noted that applicants often refer to the inventive core material as an elongated, non-stretchable, core material. Applicants'core material is elongated because it extends the entire length of applicants'marker tape, and as noted herein, the length of applicants'marker tape may well be several thousand feet. Applicants'elongated, core material is generally non-stretchable because it is intended to take the strain of the pullback operation and transmit this strain to the rest of applicants'marker tape. If applicants elongated, core material was stretchable, as for example the stretchable core material embodiment shown in commonly owned publication WO 2017/210370 A1, it would be very difficult for applicants'marker tape to be successfully installed in a Horizontal Directional Drilling machine pullback operation. Having said that, applicants recognize that any material, no matter how strong, will stretch-at least somewhat-if enough force is applied to the material. What applicants mean by the term non-stretchable, as used herein, is that applicants'core material does not stretch to any appreciable amount during its intended use. This is in stark contrast to the stretchable core material embodiment shown in commonly owned publication WO 2017/210370 A1. This core material, illustrated in FIGS. 42 and 49 and discussed in paragraphs [0108] and [0116] [of WO 2017/210370 A1] is designed to stretch, without breaking, up to 1.5 times its original length in normal usage. On the other hand, applicants'elongated, non-stretchable core material is designed to not stretch to any appreciable amount during it's intended use.

### DETAILED DESCRIPTION OF THE INVENTION

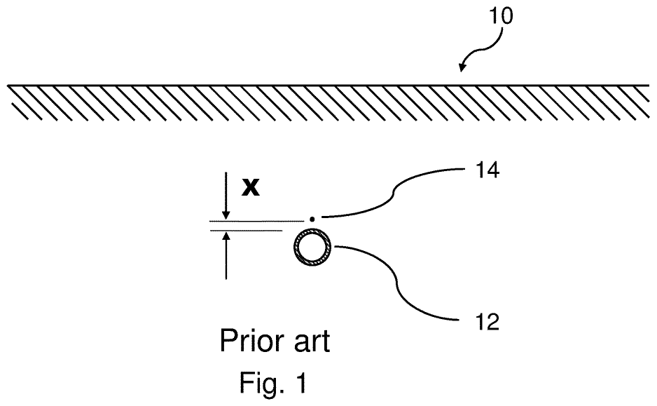

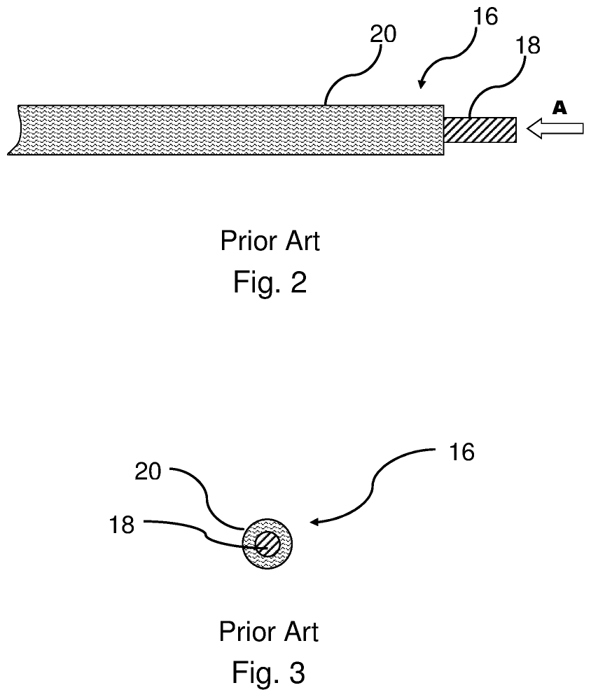

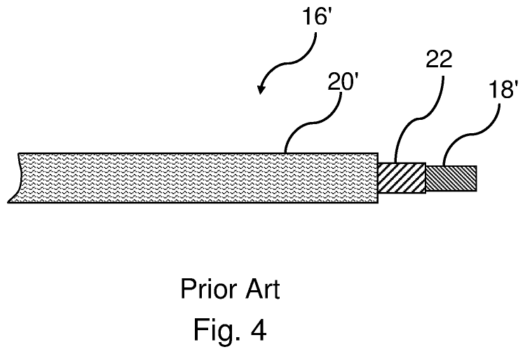

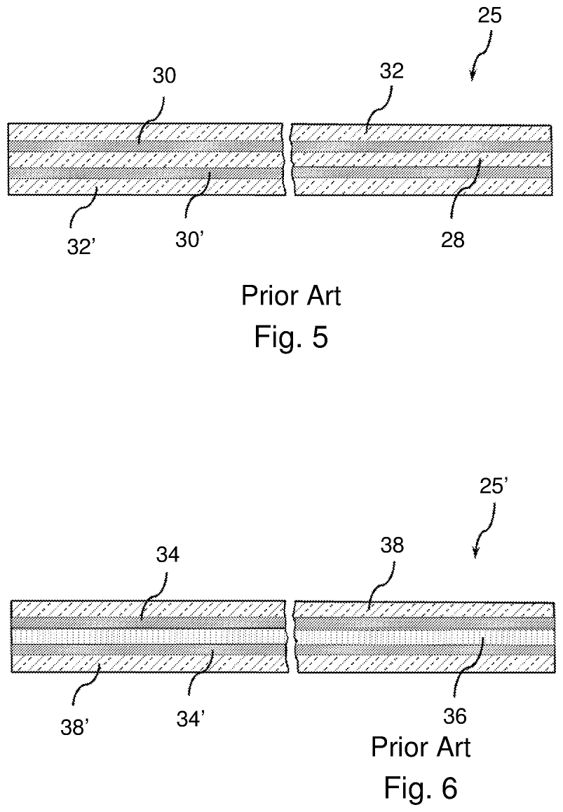

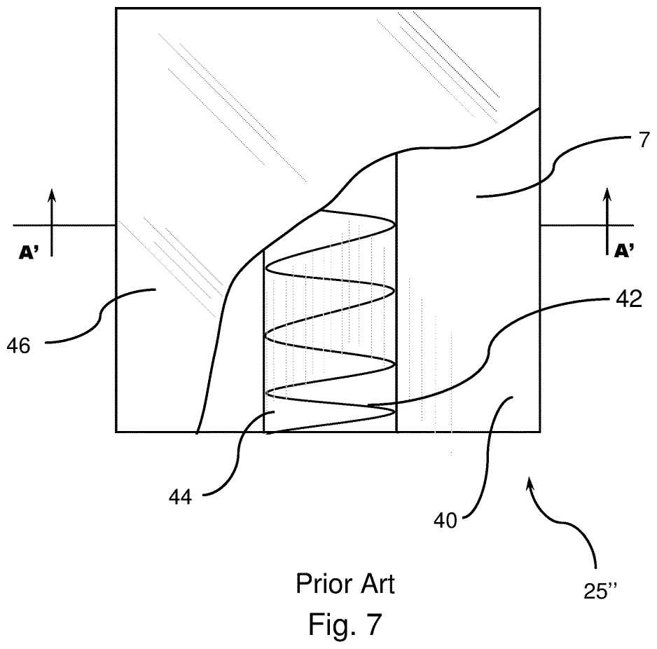

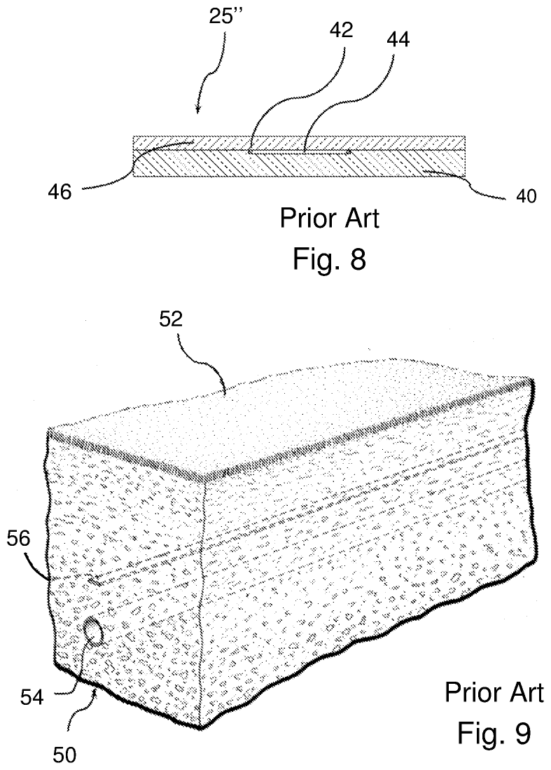

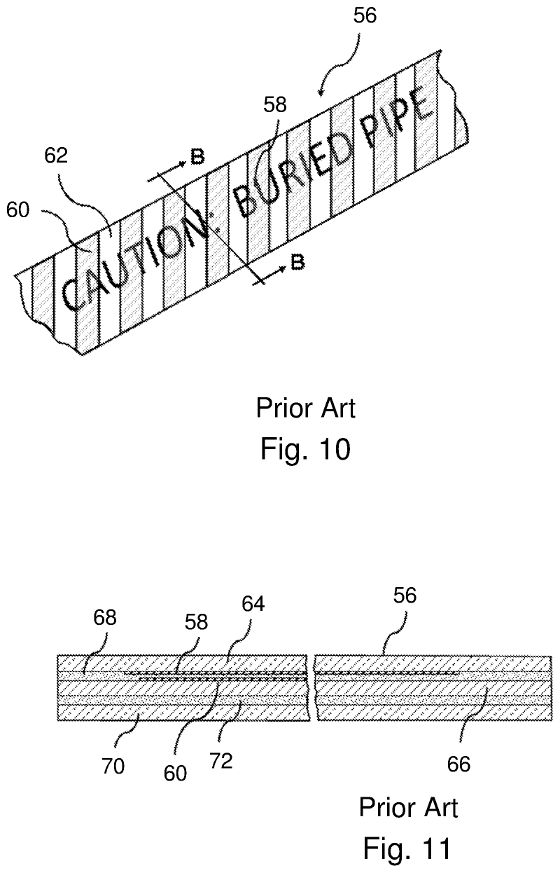

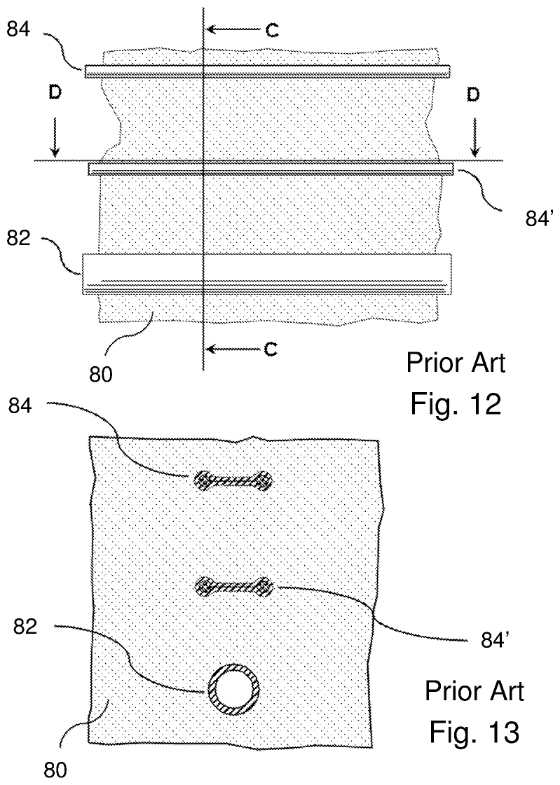

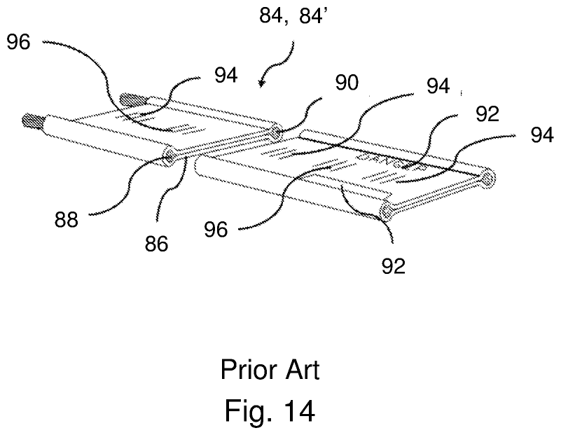

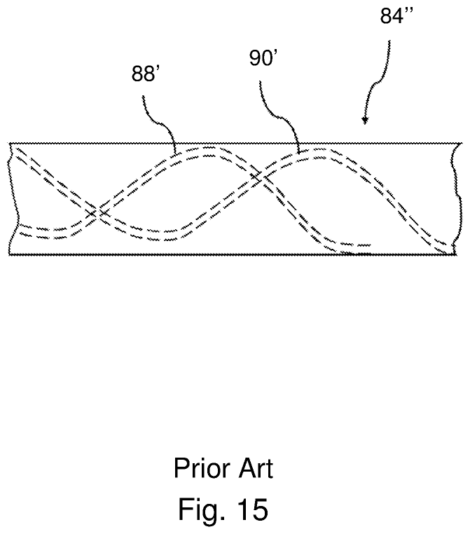

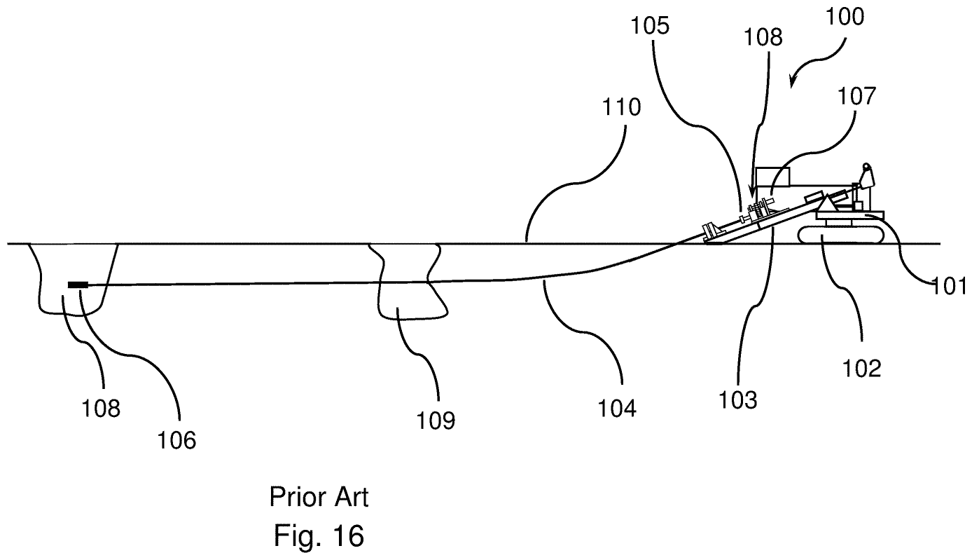

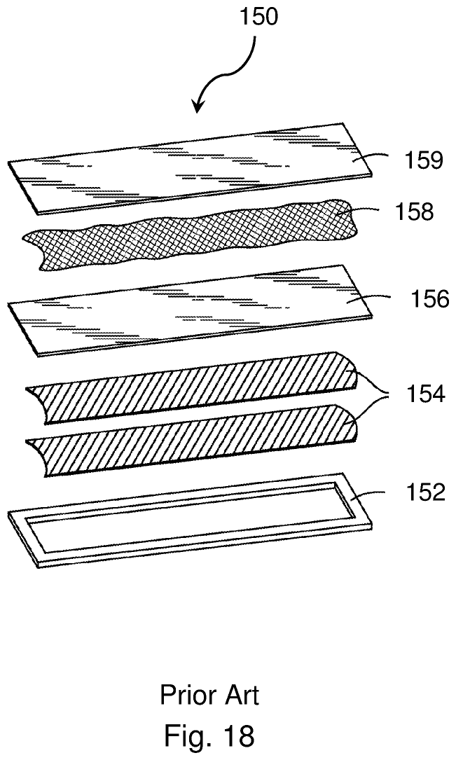

Since FIGS. 1-18 have already been described above in the BACKGROUND OF THE INVENTION section, these figures will not be discussed in detail at this time.

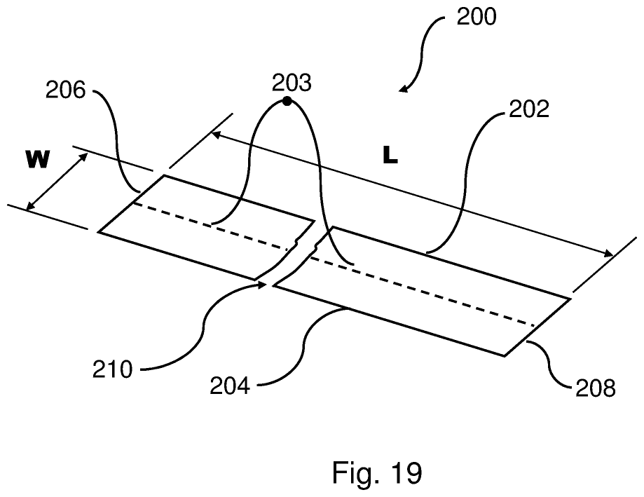

Applicants are using strip-like materials to make various components of applicants'detectable marker tape. In addition, a number of the physical elements of strip-like materials are being claimed. It is therefore considered desirable to indicate exactly what applicants mean by the use of these elements. FIG. 19 illustrates a generic strip 200 with a length L, width W, a first side 202, a second side 204, a leading edge 206 and a trailing edge 208. First and second side edges 202, 204 are generally parallel to each other and form straight lines. It is also noted that strip 200—since it has parallel sides 202, 204 also has an imaginary centerline 203 which is not actually a visible physical feature in this drawing [as side edges 202, 204 are visible features] and therefore imaginary centerline 203 is illustrated herein as a dotted line. Leading edge 206 and trailing edge 208 may form straight lines and may be parallel to each other or they may not be parallel. For convenience in illustrating the invention, strip 200 has been generally shown herein as a parallelogram; however, as long as sides 202, 204 are generally parallel, there is no necessity for leading edge 206 and trailing edge 208 to be straight lines. There is also no necessity that they be parallel to each other. For example, leading edge 206 and trailing edge 208 could basically have any desired shape-semicircular, oval, jagged or any other shape. It is also to be noted that applicants are using strips which are much longer than they are wide. For example, when manufactured as marker tape, a typical value for length L for strip 200 would be between 200 and 1000 feet [or approximately 61 m-305 m], while a typical value for width W might be between approximately 4 inches and 12 inches [or approximately 10.2 cm-30.5 cm]. This is one reason why the interruption 210 is shown in FIG. 19 to indicate that the strip is quite long. When applicants state that the length of a strip is much longer than the width of the strip is wide, they mean that the length is intended to be many, many times longer than the strip is wide. As noted, supra, when manufactured, marker tape may be hundreds [or thousands] of feet long while the width of the strip will normally be less than one foot wide. This is what applicants mean when they say that the length of the strip is much longer than the strip is wide. It is also noted that sections of marker tape are often tied together to form marker tapes that may extend for many miles because it is well known that the buried infrastructure which the marker tape is to “mark” may well extend many miles.

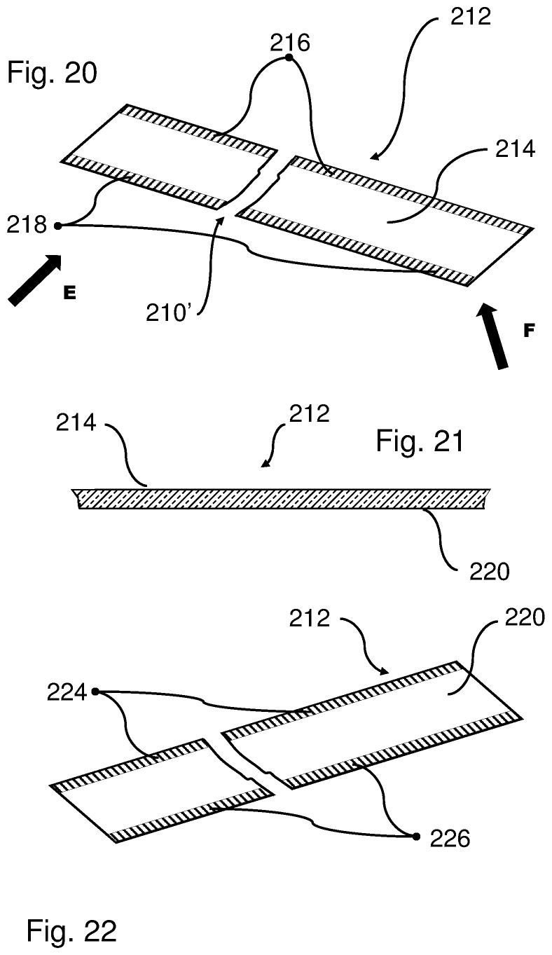

FIG. 20 shows a strip 212 similar to strip 200 with interruption 210′ to indicate that strip 212 is much longer than it is wide although it should be noted an interruption such as those shown by 210, 210′ have not always been included in applicants'drawings of strips and the inventive detectable marker tape. Strip 212 also is shown with a top surface 214 and first side edge 216 at one lateral portion of top surface 214 and a second side edge 218 at the other lateral portion of strip 212. FIG. 21 illustrates a side view of strip 212 taken along arrow E of FIG. 20. Strip 212 is shown with top surface 214 and bottom surface 220 both being visible in this figure. FIG. 22 is a bottom view of strip 212 taken along arrow F of FIG. 20 and shows bottom surface 220 and first side edge 226 at one lateral portion of bottom surface 220 of strip 212 and second side edge 224 at the other lateral portion of bottom surface 220 of strip 212.

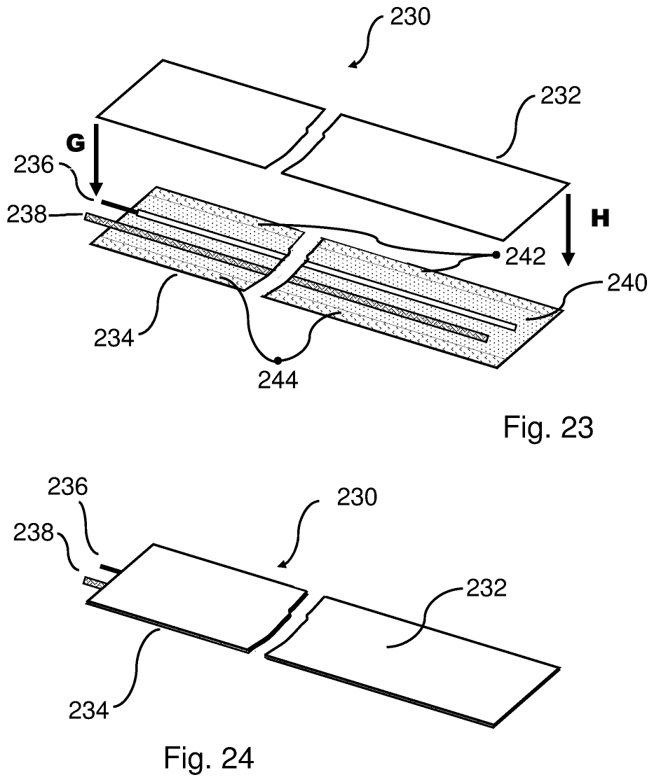

FIG. 23 shows an exploded view of detectable marker tape 230 according to the invention with the protective envelope being formed from joined top strip 232 and bottom strip 234. Tracer wire 236 and elongated, non-stretchable, core material 238 are shown on upper surface 240 of bottom strip 234. First side edge 242 of upper surface 240 of bottom strip 234 and second side edge 244 of upper surface 240 of bottom strip 234 are covered with adhesive which is shown by the stippled shading of first and second side edges 242 and 244 respectively. In addition, adhesive is shown by the stippling covering the entire upper surface 240 of bottom strip 234. Arrows G and H show how top strip 232 is assembled to bottom strip 234 to encapsulate elongated, non-stretchable core material 238 and tracer wire 236.

Assembled strip 230 is shown in FIG. 24 with elongated, non-stretchable core material 238 and tracer wire 236 extending from one end of the protective envelope formed by the adhered assembly of top strip 232 and bottom strip 234.

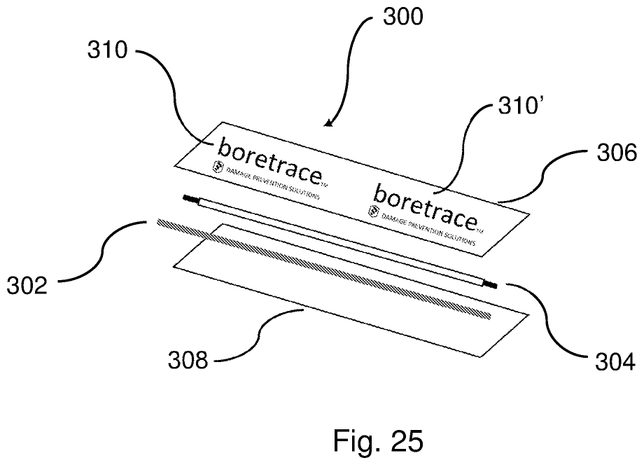

An exploded view of inventive detectable marker tape 300 is shown in FIG. 25. Detectable marker tape 300 comprises a strong, elongated, non-stretchable, core material 302 encapsulated within the protective envelope which, in this embodiment, is formed from a top strip 306 and a bottom strip 308 with both strips being made from thermoplastic material and with both strips 306 and 308 being joined together. Marker tape 300 also carries a conventional, insulated copper tracer wire 304 which tracer wire is also encapsulated within the protective envelope formed by joined top strip 306 and bottom strip 308. Top strip 306 may carry indicia 310, 310′ on the outer surface thereof. Indicia 310, 310′ are shown as a brand name, but the indicia could be warning indicia or other indicia indicating information concerning the buried infrastructure being protected. For example, it is customary in this art to color code strips 306 and 308 depending upon the type of buried infrastructure being protected. The standard color coding would be yellow for a gas utility; orange for telephone and/or telecommunications utilities; green for wastewater utilities; blue for water utilities; and red for power utilities. Thus strips 306 and 308 would be colored yellow if they were intended to protect a gas utility. Additional warning indicia could be imprinted on top of the yellow color coating. Of course, strips 306, 308 could be made from material which already has the proper color. The strips may be made from any suitable thermoplastic material such as polyethylene, polypropylene, polyvinylidene chloride [e.g. SARAN®], or a fluorocarbon. A typical thickness for strips 306, 308 is from about 0.001 to 0.002 inches [approximately 2.54×10⁻³ cm-5.08×10⁻³ cm]. It is also noted that tracer wire 304 does not have to be insulated since the protective thermoplastic strips 306, 308 can act as insulation and protective material for tracer wire 304. Strips 306, 308 may be joined, sealed or secured together using adhesive or they may be laminated together, be heat sealed, or be ultrasonically welded. In addition to these joining processes, any other suitable joining process known in the art may also be used. It would also be possible to extrude strips 306, 308 as a unitary envelope over elongated, non-stretchable, core material 302 and tracer wire 304. In this embodiment of applicants'detectable marker tape, elongated, non-stretchable, core material 302 and tracer wire 304 are adhered to one or both of protective thermoplastic sheets 306 and/or 308.

It is important that the elongated, non-stretchable core material and remote locator device(s) are each well-secured to the protective envelope. The elongated, non-stretchable core material has to be properly secured to the protective envelope so that it can take the pulling strain imposed by the pullback procedure and transfer that pulling strain directly to the protective envelope and thus enable the detectable marker tape to be reliably pulled back through the borehole created by the Horizontal Directional Drilling machine as further described, infra. It is also important that the remote locator device(s) be properly secured to the protective envelope because the spacing between the multiple remote locator device(s) is important in enabling proper location of the detectable marker tape once buried. Once properly emplaced at the desired interval along the length of the detectable marker tape, it is not desirable that the remote locator device(s) move after emplacement. Each manufacturer of the particular individual remote locating device used in applicants'detectable marker tape will specify a desired interval between the multiple remote locator devices along the length of the marker tape. Obviously, using the optimal number of remote locator devices in a particular length of marker tape is desirable. Using fewer remote locator devices than are needed can adversely affect detection reliability. Using more remote locator devices that optimal will adversely affect costs. In order to achieve optimal usage, it is desirable to fasten a substantial portion of the outer surface of the elongated, non-stretchable core material and the outer surface of the remote locator devices to the protective envelope. This is accomplished by securing the protective envelope to the outer surface of the elongated, non-stretchable core material or the outer surface of the remote locator devices by adhesion with an adhesive, by lamination, by heat sealing, by ultrasonic welding or by any other suitable joining process. Since the preferred materials for the protective envelope are thermoplastic materials, as noted supra, it is relatively easy to use the natural adhesive properties of heated thermoplastic materials to secure the elongated, non-stretchable core materials and remote locator devices to the protective envelope. When applicants state that a substantial portion of the outer surface of the elongated, non-stretchable core material is secured to another surface, such as the inside surface of the protective envelope, applicants mean that at least 50% of the outer surface of the elongated, non-stretchable core material is secured to the other surface. In like manner, when applicants state that a substantial portion of the outer surface of a remote locator device is secured to another surface, such as the inside surface of the protective envelope, applicants mean that at least 50% of the outer surface of the remote locator device is secured to the other surface.

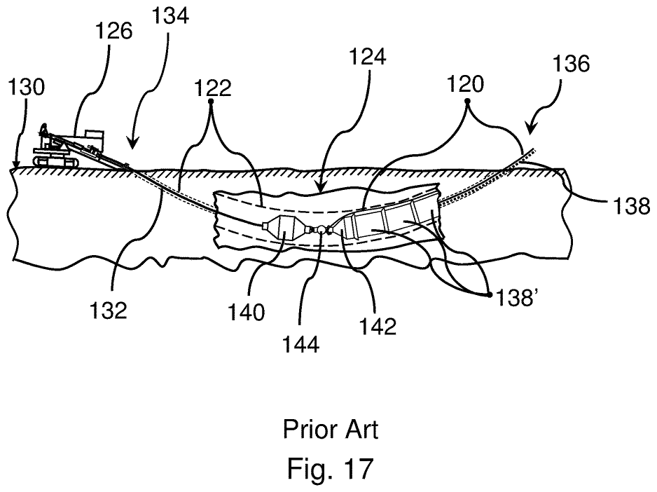

In a typical pullback operation, such as that shown in FIG. 17 and described supra, it is possible to fasten detectable marker tape 300 to the coupler 142 holding a non-metallic utility by tying only the elongated, non-stretchable, core material 302 to coupler 142. This can be accomplished by ripping off a certain length of the top 306 and bottom 308 thermoplastic strips to expose a desired length of elongated, non-stretchable, core material 302 and tracer wire 304. Exposed tracer wire 304 is nipped off at the edge of the undisturbed portion of the detectable marker tape 300 [where top strip 306 and bottom strip 308 are still secured together] and exposed elongated, non-stretchable, core material 302 is securely tied in a knot about the coupler 142. The pullback operation can then proceed as normal with the pulling stresses being applied directly to strong, elongated, non-stretchable. core material 302 and then transmitted to strips 306 and 308 and only then to tracer wire 304. Of course, thermoplastic strips 306, 308 will also protect tracer wire 304 from pullback induced damage. This means that it will no longer be necessary to tie several tracer wires to coupler 142 prior to the pullback operation in order to have at least one tracer wire survive the pullback operation. Because of this construction, the tensile strength of tracer wire 304 is not as critical as it is in a conventional pullback operation where the pulling forces are applied directly to the tracer wire. It is also possible [although not necessary] to taper down the broad leading edge of the undisturbed portion of detectable marker tape 300 in the position closest to coupler 142 in order to protect the thermoplastic sheets during pullback. It is also possible to place strong tape around the free edge of the undisturbed portion of detectable marker tape 300 to seal strips 306, 308 tightly together and to the exposed portion of elongated, non-stretchable, core material 302 and to further protect the rest of the marker tape 300 during pullback.

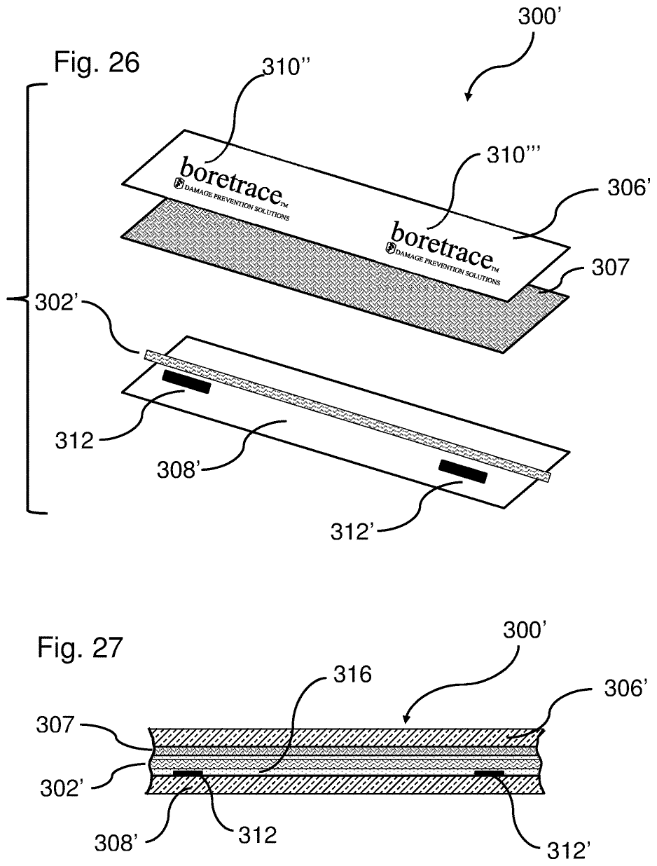

FIG. 26 shows an exploded view of a second embodiment of detectable marker tape 300′.

The main difference between detectable marker tape 300 shown in FIG. 25 and detectable marker tape 300′ shown in FIG. 26 is that detectable marker tape 300′ does not utilize tracer wire 304 to aid in locating the buried detectable marker tape 300′. Instead, detectable marker tape 300′ has remote locator devices 312, 312′ affixed at predetermined intervals to the inside surface of bottom thermoplastic strip 308′. It should be noted that remote locator devices 312, 312′ could equally well be affixed at predetermined intervals to the inside surface of top thermoplastic strip 306′. These predetermined intervals will be determined by the type of remote marker used and by the intended burial depth. The manufacturer of the particular remote locator device used will also have specifications as to the remote marker separation. The particular field conditions at the burial site will also tend to affect the remote locator separation distance. The type of soil that marker tape 300′ is to be buried in, the burial depth, the moisture content, and other environmental conditions will determine the exact spacing used in a particular field situation. Remote locator devices 312, 312′ could be RF markers, magnetic markers, RFID markers, radioactive markers, magnetostrictive markers, simple chunks of metal or any type of suitable marker which can be detected when buried underground. Indicia 310″, 310′″ are carried on the upper surface of thermoplastic sheet 306′ and can comprise various warning indicia, identification indicia and/or suitable color codings.

FIG. 26 also illustrates how one [or both] thermoplastic strips 306′, 308′ can be reinforced with a layer of fabric 307 fastened to the bottom surface of top thermoplastic strip 306′ [or top surface of bottom thermoplastic strip 308′]. Layer 307 can be made from woven or knit fibers, either vegetable [e.g., cotton] or animal [e.g., wool], or from manufactured cloth made from fibers such as nylon, rayon, polyethylene, polypropylene, aramid fibers, polyvinylidene chloride [e.g. Saran™] or fluorocarbon, etc. FIG. 27 illustrates a cross-section of an assembled section of detectable marker tape 300′ which is shown exploded in FIG. 26. Top strip 306′ is fastened to fabric layer 307 by adhesive [not shown] while elongated, non-stretchable, core material 302′, bottom strip 308′ and remote locator devices 312, 312′ are all fastened to the combination of top strip 300′ with the adhered fabric layer 307 by adhesive 316.

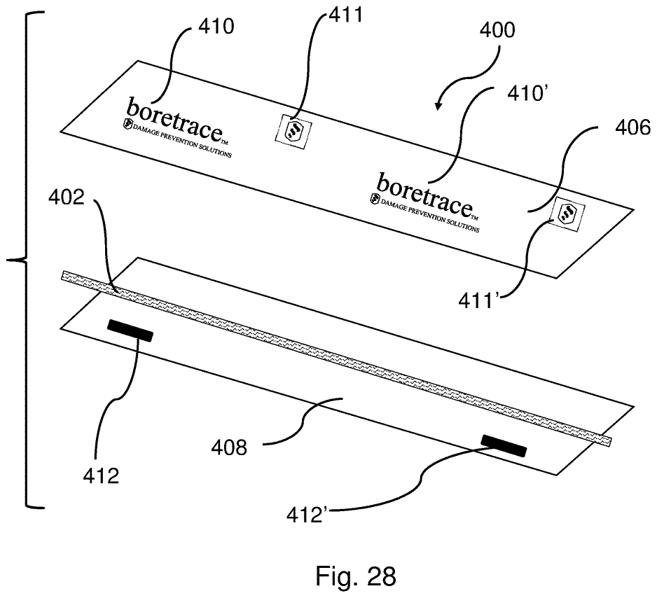

FIG. 28 illustrates a third embodiment of detectable marker tape 400. Top strip 406 carries indicia 410, 410′ on the upper surface thereof. Indicia 410, 410′ can be warning indicia or a brand name as shown herein. Optically variable indicia 411, 411′ are shown as being carried on the upper surface of top strip 406; however, they could equally well be carried on the bottom surface of bottom strip 408.

Optically variable indicia 411, 411′ are known and used, for example, on driver's licenses and other types of identification devices as taught by Jones et al. U.S. Pat. No. 7,694,887. Indicia 411, 411′ could be warning indicia or merely used to identify the type of marker tape. In FIG. 28 indicia 411, 411′ represent a logo of the manufacturer of marker tape 400. Detectable marker tape 400 also comprises elongated, non-stretchable, core material 402 and multiple remote locator devices 412, 412′ which are spaced along the length of the upper surface of bottom strip 408 at a predetermined spacing.

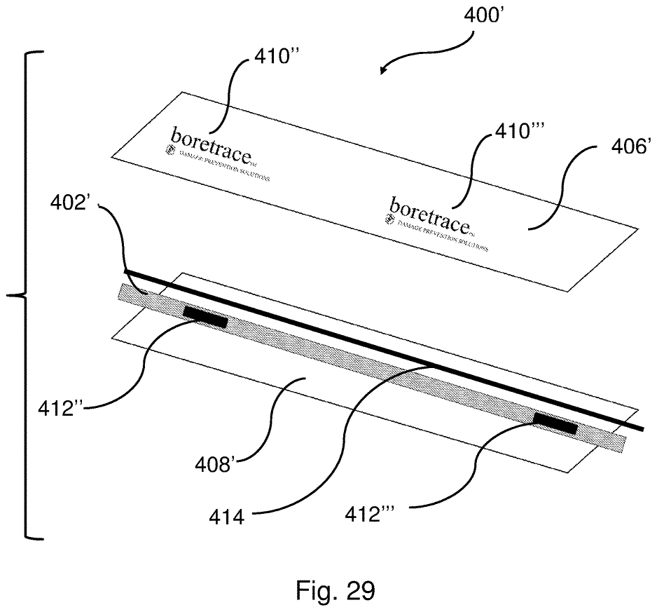

FIG. 29 shows an exploded view of a fourth embodiment of the inventive detectable marker tape. Detectable marker tape 400′ is substantially similar to detectable marker tape 400 shown in FIG. 28 with similar numerals illustrating similar components except that in detectable marker tape 400′ remote locator devices 412″, 412′″ are actually affixed to the outer surface of elongated, non-stretchable, core material 402′ rather than being affixed to the upper surface of bottom strip 408′. Indicia 410″, 410′″ are imprinted on the upper surface of top strip 406′, as shown. However, it is noted that the upper surface of top strip 406′ does not have optically variable indicia thereon as is shown in FIG. 28. It is within the scope of the invention to have several different types of remote locator devices included in a single detectable marker tape. For example tracer wire, magnetostrictive markers, RF markers, RFID markers, radioactive markers, simple chunks of metal, or any type of suitable marker in any combination or sub-combination could be incorporated within a single detectable marker tape. This is illustrated in FIG. 29 by the inclusion of tracer wire 414 along with the remote locator devices 412″, 412′″. As noted supra, remote locator devices 412″, 412′″ may be RF markers, magnetic markers, RFID markers, radioactive markers, magnetostrictive markers, simple chunks of metal or any type of suitable marker which can be detected when buried underground. It was noted supra that, because of the construction of detectable marker tape 400′, it is not absolutely necessary to have an insulation layer on tracer wire 414 and this is illustrated in FIG. 29 since tracer wire 414 is shown therein as bare copper which may be solid or stranded, as desired.

Eventually, the buried infrastructure which detectable marker tapes 230, 300, 300′, 400 and 400′ are protecting will need to be dug up for repairs, replacement or other purposes or there will be other excavation required near the buried infrastructure. When this happens, detectable marker tapes 230, 300, 300′, 400 and 400′ will make it easier to accurately locate the buried infrastructure and to safely excavate it or avoid it altogether when doing other excavation. To this end, it is helpful to have some special treatments on the outer [or exposed] surface(s) of thermoplastic strips 232, 306, 306′, 406, 406′, 234, 308, 308′, 408, or 408′ to increase marker tape visibility and aid in location of the marker tape. For example, the outer surfaces of the top and bottom thermoplastic strips can be coated with any suitable known hydrophobic coating to prevent good wetting of the outer surfaces of strips 232, 306, 306′, 406, 406′, 234, 308, 308′, 408, or 408′ by ground moisture. This will tend prevent soil [in the form of mud] from adhering to the outer surfaces of strips 232, 306, 306′, 406, 406′, 234, 308, 308′, 408, or 408′ and thus aid in safe excavation by making the surfaces much easier to see in low light situations such as might be found at the bottom of an excavation trench. In addition, a luminescent coating could be applied to the outer surfaces of strips 232, 306, 306′, 406, 406′, 234, 308, 308′, 408, or 408′. This would mean that these surfaces would glow in the dark which will also aid in the location of the detectable marker tape when excavating the utility. A highly reflective coating could also be applied to the outer surfaces of strips 232, 306, 306′, 406, 406′, 234, 308, 308′, 408, or 408′. This would mean that the surfaces would reflect large amounts of light when illuminated. Numerous localities use these types of coatings on traffic signs such as stop signs. The coatings are often applied to the signposts as well as to the signs themselves and when illuminated by vehicle headlights at night, the whole sign, signpost and all simply “jumps out” at the driver. Obviously, this feature could be useful for location of the detectable marker tape-particularly in low light situations such as you might find in a trench. Since the detectable marker tape is essentially right on top of the buried utility, location of the marker tape means you have essentially located the buried utility.

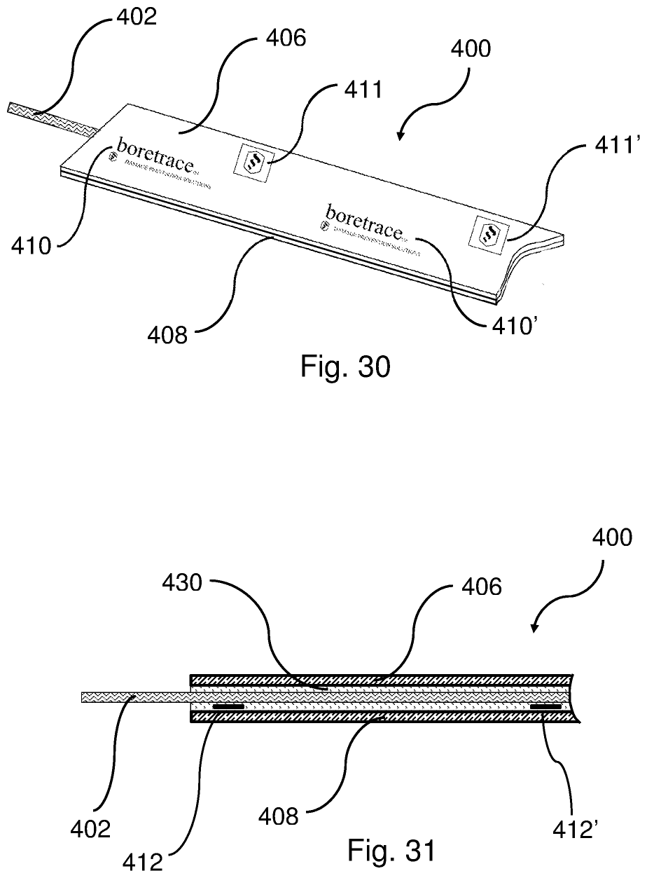

FIG. 30 shows an assembled view of the third embodiment of the detectable marker tape 400. Detectable marker tape 400 has the top strip 406 of thermoplastic material joined to bottom strip 408 of thermoplastic material with a portion of elongated, non-stretchable, core material 402 extending from one end of the elongated detectable marker tape 400. Optically variable indicia 411, 411′ are attached to the upper surface of strip 406 along with indicia 410, 410′. It is to be understood that detectable marker tape 400 may actually be hundreds—even thousands—of feet long [or longer] as it is intended to mark a lengthy underground utility. It is shown shorter, for convenience, in the drawings, but in reality, detectable marker tape 400 would be quite long. It is envisioned that detectable marker tape 400 will be sold and shipped wound on reels with approximately one thousand feet of detectable marker tape on a single reel. In addition, it is to be understood that detectable marker tape 400 may be sold and shipped with elongated, non-stretchable, core material 402 extending from one end. This will make it easy to tie this exposed portion of elongated, non-stretchable, core material 402 to the Horizontal Directional Drilling Machine as will be further described infra. It is also possible that detectable marker tape 400 may not have elongated, non-stretchable, core material 402 extending from one end of detectable marker tape 400. Rather, at the installation site, strips 406 and 408 could be separated [or just cut away] to expose enough of elongated, non-stretchable, core material 402 so that this exposed portion of elongated, non-stretchable, core material 402 can be affixed to the pulling head of a conventional Horizontal Directional Drilling machine as will be further described infra. In this circumstance, if detectable marker tape 400 incorporates tracer wire [as shown in FIGS. 23, 25 and 29], the tracer wire exposed by cutting away strips 406 and 408 would be nipped back to the joined strips 406, 408 before elongated, non-stretchable core material 402 would be tied to the Horizontal Directional Drilling machine for pullback.

FIG. 31 shows a cross-sectional view of the assembled marker tape 400 of FIG. 30. Top strip 406 of thermoplastic material is shown joined to bottom strip 408 of thermoplastic material by a layer of adhesive 430. It should be noted that top thermoplastic strip 406 could be joined to bottom thermoplastic strip 408 by thermowelding, heat sealing or by any other suitable method as discussed supra. A portion of elongated, non-stretchable core material 402 extends from one end of detectable marker tape 400. Remote locator devices 412, 412′ are adhered to the top surface of bottom strip 408 of thermoplastic material. As noted, supra, detectable marker tape 400 will actually be quite long. It is herein shown much shorter, for convenience, in the drawings but it may well be miles long.

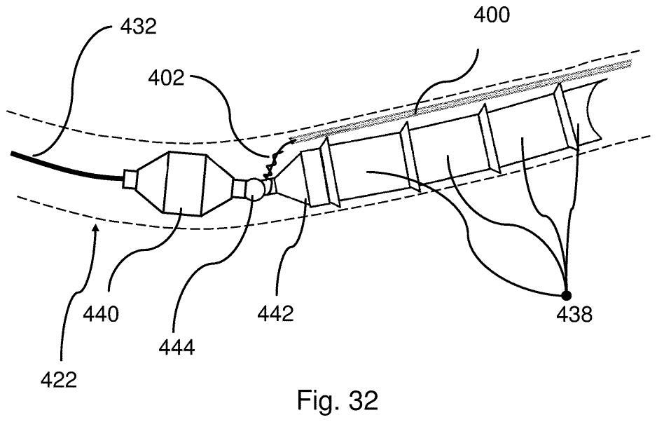

FIG. 32 shows how detectable marker tape 400 is installed in a conventional pullback operation along with non-metallic utility 438. This figure is similar to applicants'FIG. 17, supra, which was itself taken from Groebner et al, U.S. Pat. No. 7,367,748 and similar elements have similar numbers. Borehole 422 is shown in dotted lines and has been previously drilled in a conventional manner. When it is desired to install non-metallic utility 438 in borehole 422, the drill head [not shown in FIG. 32] is removed from drill string 432 and one end of reamer 440 is attached to drill string 432. Coupler 442 is then attached to the other end of reamer 440 via joint 444. A length of elongated, non-stretchable, core material 402 is exposed from one end of marker tape 400. As noted supra, this exposed end may have been provided during manufacture or it may be made on site by removing portions of the upper and lower strips 406, 408. The exposed elongated, non-stretchable, core material 402 is then securely tied around one end of coupler 442 and the pullback operation is initiated. The pullback forces are applied directly to elongated, non-stretchable, core material 402 and then transmitted to detectable marker tape 400 which is pulled along with non-metallic utility 438 and installed in borehole 422.

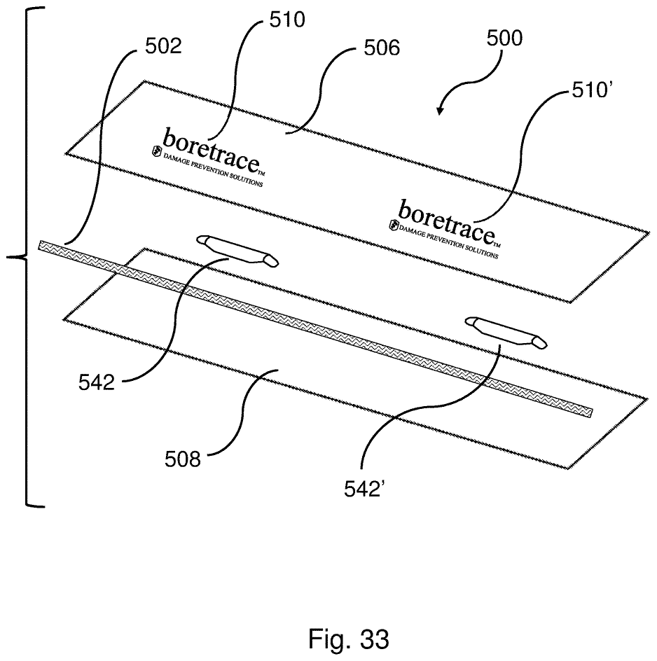

FIG. 33 shows an exploded view of a fifth embodiment of detectable marker tape 500. This embodiment of the detectable marker tape comprises a top thermoplastic sheet 506, a bottom thermoplastic sheet 508 and elongated, non-stretchable, core material 502. Multiple magnetomechanical locator devices 542, 542′ are spaced along the length of detectable marker tape 500. These magnetomechanical locator devices are similar to those disclosed in Doany et al. U.S. Pat. No. 9,638,822 owned by 3M Innovative Properties Company, of St. Paul, Minnesota. Indicia 510, 510′ are shown on the upper surface of top thermoplastic strip 506. Indicia 510, 510′ may be warning indicia or identification indicia as discussed supra. It is, of course, desirable to treat the upper surface of strip 506 and/or the lower surface of strip 508 with suitable known hydrophobic coatings, luminescent coatings, or highly reflective coatings as discussed supra to make detectable marker tape 500 more visible in low-light conditions such as those which might be encountered in the bottom of an excavation trench.

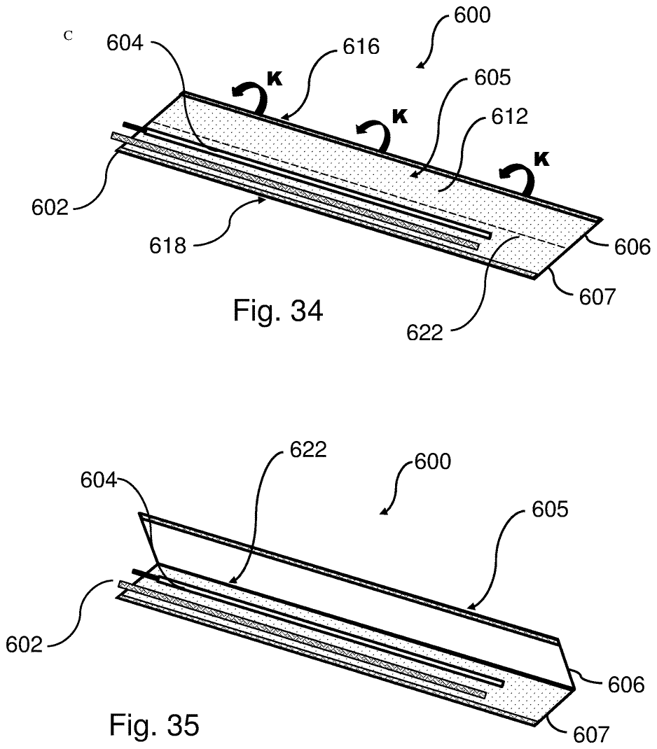

FIGS. 34-38 illustrate one method of making detectable marker tape 600. In FIG. 34, strip of thermoplastic material 605 having upper surface 612 is laid out in a substantially flat condition. Elongated, non-stretchable core material 602 and tracer wire 604 are laid on the upper surface 612 of strip 605. [It is noted that elongated, non-stretchable core material 602 and tracer wire 604 are illustrated and numbered in each of FIGS. 34-38 but may not be further mentioned in the discussion of these figures.] First side edge 616 is shown at one lateral portion of strip 605 and second side edge 618 is shown at the opposing lateral portion of strip 605. Imaginary centerline 622 divides strip 605 into two approximately equal panels 606 and 607. Panels 606, 607 are shown herein as being joined at an angle of 180°. Centerline 622 of strip 605 is shown in FIG. 34 as a dotted line because it merely designates a portion of strip 605 which divides panels 606, 607 rather than an explicit feature. Adhesive is applied at least to first and second side edges 616, 618 and preferably to the entire upper surface 612 of strip 605. This adhesive [represented in the figures as stippling] will secure elongated core material 602 and tracer wire 604 to upper surface 612. The arrows K in FIG. 34 show how strip 605 will be folded over to form the finished detectable marker tape 600.

FIG. 35 shows the first step in the folding of strip 605 about centerline 622. It is noted that strip 605 centerline 622 is herein shown as a solid line. Because strip 612 is now folded, centerline 622 now forms the fold in strip 612 and is a visible feature of the partially folded strip. Centerline 612 is visible as a fold line in this intermediate step. Panel 606 is folded over centerline 622 in the direction shown in FIG. 34 by arrows K. This leaves panel 606 now joined to panel 607 at an angle less than 90°.

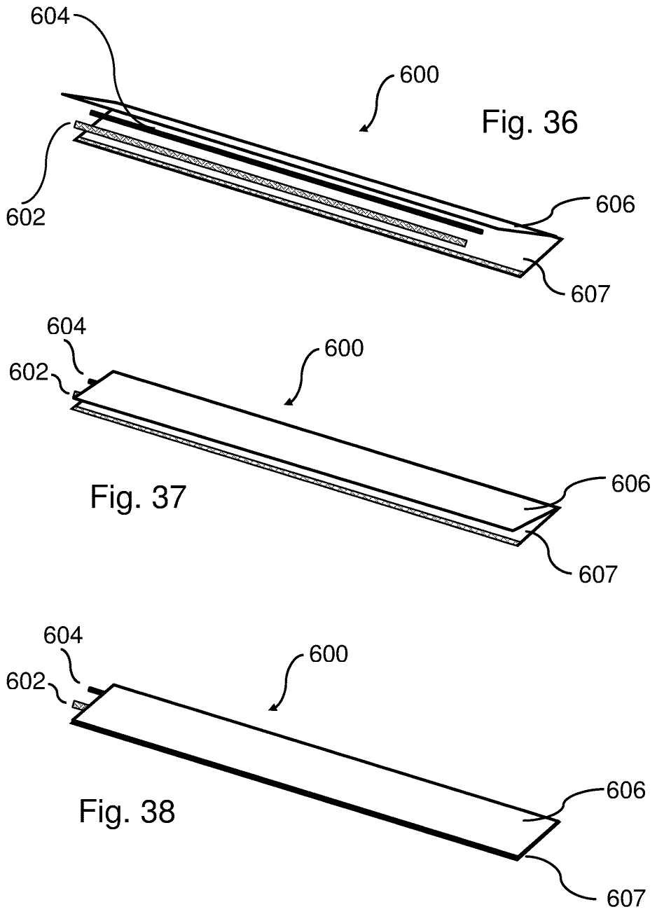

FIG. 36 shows panels 606 and 607 folded over more than the showing of FIG. 35. Panels 606, 607 are now joined by an angle of approximately 45°.

FIG. 37 shows panels 606, 607 folded over more than the showing of FIG. 36. Panels 606, 607 are now joined by an angle of approximately 15°.

FIG. 38 shows panels 606, 607 completely folded and joined together to form the protective envelope for the finished detectable marker tape 600.

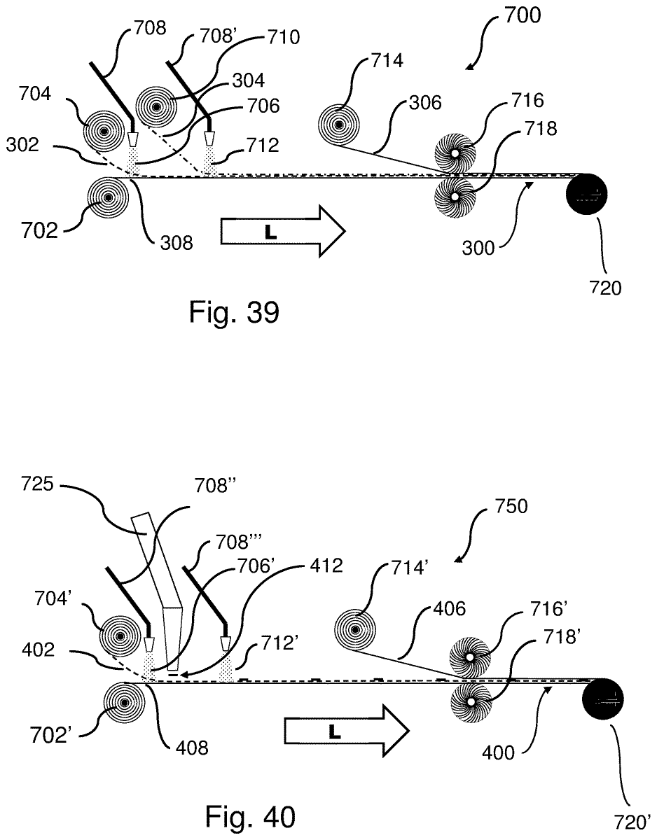

FIGS. 39, 40 42-44 illustrate other methods which could be used to make the finished detectable marker tape.

FIG. 39 shows a schematic representation of an assembly line 700 for making detectable marker tape 300 shown in FIG. 25. Bottom thermoplastic strip 308 is fed in the direction of arrow L from bottom strip feed reel 702. Elongated, non-stretchable, core material 302 is fed from elongated, non-stretchable, core material feed reel 704 in the direction of arrow L and laid upon the upper surface of bottom strip 308. Before elongated, non-stretchable, core material 302 contacts the upper surface of bottom strip 308 the upper surface is sprayed with adhesive 706 applied by adhesive supply and nozzle 708. Thus, when elongated, non-stretchable, core material 302 touches the upper surface of bottom strip 308 it sticks to this upper surface. Tracer wire 304 is fed to the right from tracer wire feed reel 710 and laid upon the upper surface of bottom strip 308 where it sticks because of adhesive 706 previously applied to bottom strip 308 which, as noted, is moving in the direction of arrow L. Because it is important to securely fasten tracer wire 304 to the inside surface of the protective envelope formed by the joined top strip 306 and bottom strip 308, an additional adhesive spray 712 is applied to the combined bottom strip 308, elongated, non-stretchable core material 302 and tracer wire 304 by adhesive supply and nozzle 708′. Top strip 306 is fed in the direction of arrow L from top strip feed reel 714 and is joined to the upper portion of the assembly of bottom strip 308, elongated, non-stretchable, core material 302 and tracer wire 304 all of which is moving in the direction of arrow L. The assembled bottom strip 308, elongated, non-stretchable, core material 302, tracer wire 304 and top strip 306 are fed through soft nip rollers 716, 718 to secure all portions of detectable marker tape 300 together and then wound on product take-up reel 720. As discussed supra, the amount of detectable marker tape 300 wound on product take-up reel 720 may be 1000 feet or more [or approximately 305 m or more]. It is noted that soft nip rollers 716,718 may be heated if necessary to further the assembly process.

FIG. 40 shows a schematic representation of an assembly line 750 for making detectable marker tape 400 shown in FIG. 28. Bottom thermoplastic strip 408 is fed in the direction of arrow L from bottom strip feed reel 702′. Elongated, non-stretchable, core material 402 is fed from elongated, non-stretchable, core material feed reel 704′ in the direction of arrow L and laid upon the upper surface of bottom strip 408. Before elongated, non-stretchable, core material 402 contacts the upper surface of bottom strip 408 the upper surface is sprayed with adhesive 706′ applied by adhesive supply and nozzle 708″. Thus, when elongated, non-stretchable, core material 402 touches the upper surface of bottom strip 408, it sticks to this upper surface. Remote locator devices 412 are fed one at a time to the upper surface of bottom strip 408 such that the remote locator devices are spaced at the desired predetermined separation distance. Since the upper surface of bottom strip 408 is covered with adhesive because of the adhesive spray 706′, remote locator devices 412 stick to the upper surface of bottom strip 408 when they contact the upper surface; however, to make sure that the outer surface of both elongated, non-stretchable core material 402 and the outer surface of remote locator devices 412 are completely covered with adhesive, a second adhesive spray 712′ is applied by adhesive supply and nozzle 708′″. Top strip 406 is fed in the direction of arrow L from top strip feed reel 714′ and is joined to the upper portion of the assembled bottom strip 408, elongated, non-stretchable, core material 402 and spaced remote locator devices 412. The assembled bottom strip 408, elongated, non-stretchable, core material 402, spaced remote locator devices 412 and top strip 406 are fed through soft nip rollers 716′, 718′ to secure all portions of detectable marker tape 400 together and then wound on product take-up reel 720′. As discussed supra, the amount of detectable marker tape 400 wound on product take-up reel 720′ may be 1000 feet or more [or approximately 305 m or more]. It is noted that soft nip rollers 716′,718′ may be heated if necessary to further the assembly process.

It is noted that should magnetomechanical remote locator devices be used in creating a detectable marker tape it is not desirable to wind the finished detectable marker tape on a take-up reel as shown in FIGS. 39 and 40. Magnetomechanical markers similar to those disclosed by Doany et al. U.S. Pat. No. 9,638,822 and discussed supra, tend to be longer than other remote locator devices such as RF and RFID devices and can be damaged or broken when wound about a take-up reel. When using magnetomechanical devices as remote locator devices in detectable marker tape, the finished marker tape is usually fed into an elongated box and folded back and fourth upon itself in areas of the marker tape without a remote marker present.

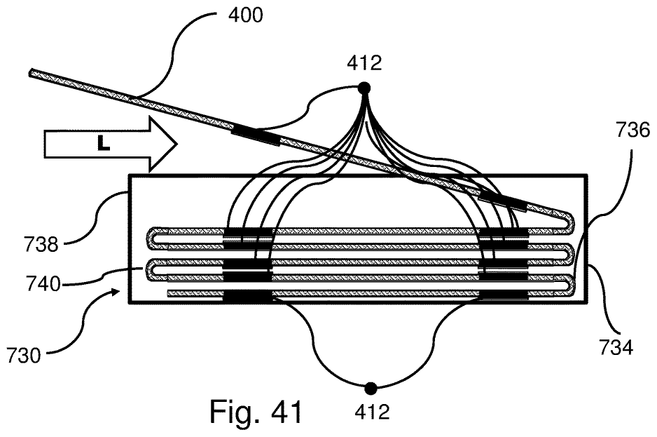

FIG. 41 shows how detectable marker tape 400 having magnetomechanical remote locator devices 412 can be taken up in an open-topped elongated box 730. Finished detectable marker tape 400 is fed along the direction of arrow L towards open-topped, elongated box 730 and laid in the bottom of open-topped, elongated box 730. As the fed detectable marker tape 400 approaches side 734 of box 730, detectable marker tape 400 is folded back over itself as shown at 736 and fed into box 730 along a direction opposite to arrow L. As the fed detectable marker tape 400 approaches side 738 of box 730 it is folded back over itself as shown at 740 and fed into box 730 in the direction of arrow L. This process is continued until elongated open-topped box 730 is filled with the desired amount of detectable marker tape 400. It is noted that space limitations when rendering drawings on paper necessitate showing open-topped box 730 much shorter than it would be in actuality.

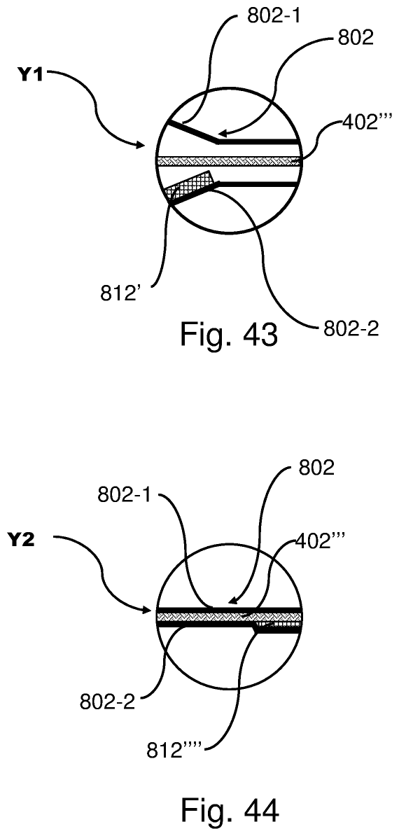

FIG. 42 illustrates a representative schematic assembly line 800 for making detectable marker tape similar to detectable marker tape 400 shown in FIG. 28 except that the protective envelope 802 of the detectable marker tape is formed by extrusion of a thermoplastic material around elongated, non-stretchable, core material 402′″ and remote locator devices 812. Remote locator devices 812, 812′, 812″, 812′″ and 812″″ are fed from remote locator device feed magazine 815 into hopper 817 and conveyed into extrusion head 820 where they are laid upon the upper surface of the bottom side of extruded protective envelope 802. Elongated, non-stretchable, core material 402′″ is fed along the direction of arrow L from elongated, non-stretchable core material feed reel 804 and is encapsulated by extrusion head 820 inside extruded protective envelope 802. It is noted that elongated, non-stretchable core material 402′″ and remote locator devices 812′, 812″, 812′″ and 812″″ are all shown in dotted lines once they are within extruded protective envelope 802. Protective envelope material is stored in thermoplastic material storage bin 822 and conveyed via feed hopper 824 into extrusion head 820 for extrusion to form protective envelope 802. The protective envelope material will normally comprise a typical thermoplastic material such as polyethylene, polypropylene, polyvinylidene chloride [e.g. Saran™] or a fluorocarbon; however, any suitable material capable of being extruded which has the necessary environmental protection properties characteristics could also be used. Protective envelope 802 is extruded in the direction of arrow L with elongated, non-stretchable, core material 402″″ and remote locator devices 812′, 812″, 812′″ and 812″″ encapsulated within protective envelope 802. The elongated, non-stretchable, core material 402″″ and spaced remote locator devices 812′, 812″, 812′″ and 812″″ [encapsulated within extruded envelope 802] are fed through heated soft rollers 824, 824′ to secure all portions of detectable marker tape together and then wound on product take-up reel 830. As discussed supra, the amount of detectable marker tape wound on product take-up reel 830 may be 1000 feet or more [or approximately 305 m or more]. Portions Y1 and Y2 of FIG. 40 are shown blown up in FIGS. 42 and 43 respectively to better illustrate portions of assembly line 800.

FIG. 43 shows portion Y1 of FIG. 40 which illustrates extruded protective envelope 802 immediately after it exits extruder head 820 and shows remote locator 812′ emplaced on lower surface 802-2 of protective envelope 802. Extruded protective envelope 802 is shown with elongated, non-stretchable, core material 402′″ and remote locator device 812′ encapsulated within protective envelope 802.

FIG. 44 shows portion Y2 of FIG. 40 which illustrates extruded protective envelope 802 with elongated, non-stretchable core material 402″″ and remote locator device 812″″ encapsulated therein. Upper surface 802-1 and lower surface 802-2 are show closely contacting elongated, non-stretchable, core material 402′″ and remote locator device 812″″. This is because the assembled detectable marker tape has passed through heated soft rollers 824, 824′ which compress the detectable marker tape to its final configuration with elongated, non-stretchable, core material 402′″ and remote locator device 812′″ being secured to both upper surface 802-1 and lower surface 802-2 of extruded protective envelope 802. It is well-known that heated thermoplastic materials have adhesive properties. Heated soft rollers 824, 824′ are used to compress the assembled product to the desired final strip-like shape and make certain that everything is properly adhered together in the final product.

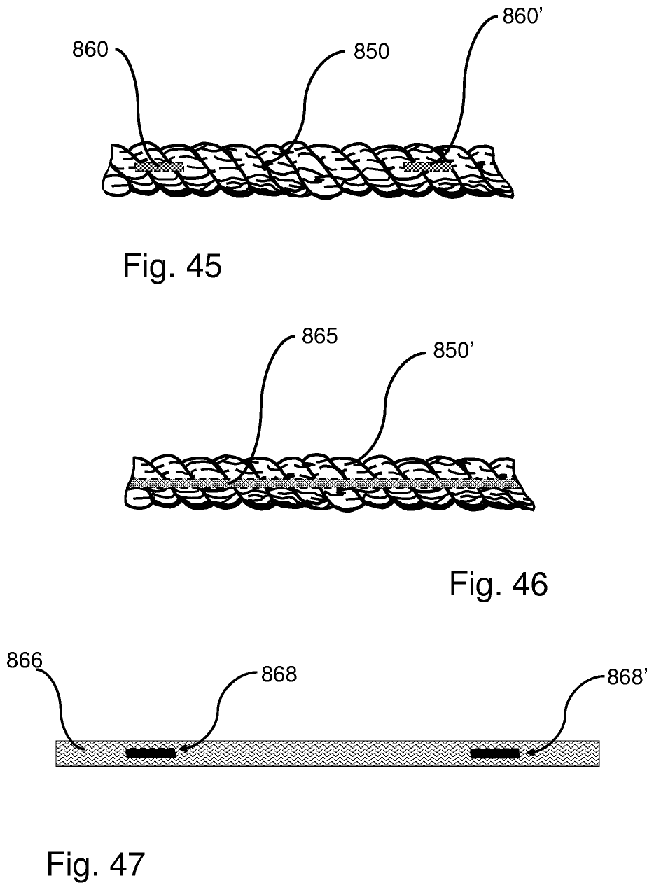

Instead of merely fastening remote locator device(s) 412″, 412′″ on the outer surface of elongated, non-stretchable, core material 402′ as shown in FIG. 29, it is possible to incorporate the remote locating device(s) within the elongated, non-stretchable, core material. FIG. 45 illustrates a rope-like elongated, non-stretchable, core material 850 with remote locator devices 860, 860′ integrated within [interwoven within] the rope-like elongated, non-stretchable, core material 850. FIG. 46 illustrates a rope-like elongated, non-stretchable, core material 850′ with tracer wire 865 incorporated within rope-like elongated, non-stretchable, core material 850′. In a similar manner, FIG. 47 illustrates how remote locator devices 868, 868′ can be incorporated within the ribbon elongated, non-stretchable core material 866.

The properties of the elongated, non-stretchable, core material are obviously important to the success of the pullback operation while the cost of the elongated, non-stretchable, core material is important to commercial success for the product. The ideal elongated, non-stretchable, core material for the inventive marker tape would be very strong in tension and very cheap. Unfortunately, high tensile strength often comes with high cost. In addition, as noted supra, the core material should be generally non-stretchable since one of the principal functions of the core material is to take the pullback stresses directly from the withdrawing drill string and pull the inventive marker tape with its enclosed tracer wire back through the borehole. This situation relieves the tracer wire of a great deal of the stress and tension imposed thereon by the conventional pullback methods described supra where the tracer wire is tied directly to the drill string and thus has to take the pullback stresses directly from the withdrawing drill string. The minimum tensile strength necessary for the inventive elongated, non-stretchable, core material to function is thought to be approximately 50 lb_{f} [or approximately 222 N]. It is envisioned that elongated, non-stretchable, core material tensile strengths could be as high as 6,000 lb_{f} [or approximately 26,690 N]—or even higher, if desired. It is envisaged that elongated, non-stretchable, core material tensile strengths of approximately 1,800 lb_{f} [or approximately 8,007 N] would be suitable for most applications. Fabric ribbons [or strips] are available in all of these strengths. For example polyester fabric ribbons are available in strengths up to about 2,000 lb_{f} [or approximately 8,896 N]. Aramid fiber ribbons in strengths of 3,000 lb_{f} [or approximately 13,345 N] and greater are also available. It is noted that polyester ribbons or ropes are also available with tensile strengths up to 6,000 lb_{f} [or approximately 26,690 N]. A generally non-stretchable yet flexible fabric ribbon with a width of one inch [2.54 cm] or less and a maximum thickness of about one quarter of an inch [or approximately 0.635 cm] will work with the inventive marker tape. One embodiment of the inventive elongated, non-stretchable, core material is a flexible polyester ribbon with a width of approximately one half of an inch [or approximately 1.3 cm], a thickness of approximately one sixteenth of an inch [or approximately 0.16 cm] and a tensile strength of approximately 1,800 lb_{f} [or approximately 8,007 N]. The flexibility and dimensions of this elongated, non-stretchable, core material make it easy to tie in a suitable knot about the front end of coupler 442, as shown above in FIG. 32, for the pullback operation. It is noted that it is also possible to use a rope-like material for the elongated, non-stretchable, core material. For example, polyester rope with a diameter of approximately three eights of an inch [or approximately 9.6 mm] is available with a tensile strength of 2,900 lb_{f} [or approximately 12,900 N]. A preferred embodiment of the marker tape which works well in all environments is an aramid fiber ribbon approximately ½ in wide and 1/16 in thick [or approximately 1.27 cm wide and 0.16 cm thick with a tensile strength of approximately 3,000 lb_{f} [or approximately 13345 N]. It is noted that the elongated, non-stretchable core material will usually be emplaced in the Detectable Marker Tape in a straight line orientation.

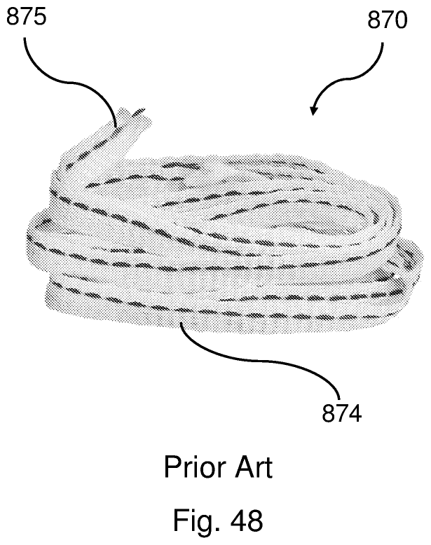

It is known in the electrical business to utilize a woven polyester ribbon as pull tape to pull wire through electrical conduits. It is also known to make a conventional polyester pull tape with copper wire woven therein. This type of pull tape is strong and flexible. A typical example of this type of polyester pull tape might be W/P 1250 Lb Polyester Pull Tape which is available in large quantities from The Ribbon Factory at 600 North Brown Street, Titusville, PA, 16354. It is also known to provide a copper wire woven into such a pull tape. This is illustrated in FIG. 48 wherein pull tape 870 comprises a typical polyester woven fabric ribbon 874 with copper wire 875 woven therein. As suggested by the name of he W/P 1250 Lb Polyester Pull Tape, the tape is available in a 1250 lb_{f} [or approximately 5560 N] tensile strength. It is also available in much higher strengths.

It is possible to provide such a polyester pull tape with copper wire suitable for use as tracer wire with the wire interwoven in the polyester ribbon as shown in FIG. 49. Here core material 880 comprises tracer wire 884 interwoven within polyester ribbon 885. Applicants can use this type of arrangement as a combined core material and tracer wire in their inventive marker tape.

The above-described embodiments of this invention are merely illustrative. Those skilled in the art may make various modifications and changes to these embodiments which still embody the principles of the invention and fall within the spirit and scope of the claims.

1. A detectable marker tape for location of a buried infrastructure with said detectable marker tape being adapted to be successfully installed during a horizontal directional drilling machine pullback operation:
said detectable marker tape comprising a protective envelope, an elongated, non-stretchable, core material, and at least one remote locating device;
said protective envelope having a first length and a first width with said first length being much longer than said first width is wide, and with said protective envelope also having an inside surface and an outside surface and with said protective envelope being formed around said elongated, non-stretchable, core material and said at least one remote locating device;
said elongated, non-stretchable, core material having
a second length and a second width,
with said second length being at least as long as said first length and with said second length being much longer than said second width is wide,
an outer surface and
a predetermined tensile strength;
said at least one remote locating device having an outer surface; and,
with a substantial portion of said outer surface of said elongated, non-stretchable, core material being secured to said inside surface of said protective envelope and with a substantial portion of said outer surface of said at least one remote locating device also being secured to said inside surface of said protective envelope.

2. The detectable marker tape of claim 1 wherein said protective envelope is formed from at least one strip of thermoplastic material with said at least one strip of thermoplastic material having a third length and a third width, with said at least one strip of thermoplastic material further having a top surface, a bottom surface and first and second side edges at each lateral portion of said top surface, respectively, of said at least one strip of thermoplastic material and with first and second side edges at each lateral portion of said bottom surface, respectively, of said at least one strip of thermoplastic material.

3. The detectable marker tape of claim 2 wherein said third length is substantially equal to said first length and said third width is substantially twice said first width;
with said at least one strip of thermoplastic material being flexible and being folded about the centerline of said at least one strip of thermoplastic material to enclose said elongated, non-stretchable, core material and said at least one remote locating device; and,
with said first side edge at said bottom surface of said at least one strip of thermoplastic material being secured to said second side edge at said bottom surface of said at least one strip of thermoplastic material to seal said first and said second side edges together and form said protective envelope.

4. The detectable marker tape of claim 3 wherein said first side edge at said bottom surface of said at least one strip of thermoplastic material is secured to said second side edge at said bottom surface of said at least one strip of thermoplastic material by said first and said second side edges being laminated together, being adhered together with adhesive, being heat sealed together or being ultrasonically welded together.

5. The detectable marker tape of claim 2 wherein said third length is substantially equal to said first length and said third width is substantially equal to said first width and said protective envelope is formed from said at least one strip of thermoplastic material and a second strip of thermoplastic material disposed below said at least one strip of thermoplastic material;
with said second strip of thermoplastic having;
a fourth length and a fourth width with said fourth length being substantially equal to said first length and said fourth width is substantially equal to said first width,
a top surface, a bottom surface and first and second side edges at each lateral portion of said top surface, respectively, of said second strip of thermoplastic material and with first and second side edges at each lateral portion of said bottom surface, respectively, of said second strip of thermoplastic material; and,
with said at least one strip of thermoplastic material being secured to said second strip of thermoplastic material at least at said first and second side edges on said bottom surface of said at least one strip of thermoplastic material and said first and second side edges at said top surface of said second strip of thermoplastic material such that said bottom surface of said at least one strip of thermoplastic material and said top surface of said second strip of thermoplastic material form said inside surface of said protective envelope.

6. The detectable marker tape of claim 5 wherein said first and second side edges at each lateral portion of said bottom surface, respectively, of said at least one strip of thermoplastic material and said first and second side edges at said top surface, respectively, of said second strip of thermoplastic material are secured together by said side edges being laminated together, being adhered together with adhesive, being heat sealed or being ultrasonically welded together.

7. canceled

8. canceled

9. canceled

10. canceled

11. The detectable marker tape of claim 5 wherein said elongated, non-stretchable, core material comprises polyester fibers, aramid fibers, or a mixture of polyester and aramid fibers.

12. The detectable marker tape of claim 5 wherein said second length is slightly greater than said first length such that said elongated, non-stretchable, core material extends outwardly from one end of said protective envelope.

13. canceled

13. canceled

14. The detectable marker tape of claim 13 wherein said at least one remote locating device further comprises multiple radioactive, metallic, ferrous metal, electronic, RF, RFID, magnetic or magnetomechanical locating devices distributed along said first length at a predetermined spacing.

15. The detectable marker tape of claim 5 wherein said at least one remote locating device comprises multiple radioactive, metallic, ferrous metal, electronic, RF, RFID, magnetic or magnetomechanical locating devices distributed along said first length at a predetermined spacing.

16. The detectable marker tape of claim 1 wherein said at least one remote locating device is incorporated within said elongated, non-stretchable, core material

17. The detectable marker tape of claim 1 wherein said at least one remote locating device is secured to said outer surface of said elongated, non-stretchable, core material.

18. The detectable marker tape of claim 1 wherein at least a portion of said outside surface of said protective envelope is treated with a highly reflective coating.

19. The detectable marker tape of claim 1 wherein at least a portion of said outside surface of said protective envelope is treated with a luminescent coating.

20. The detectable marker tape of claim 1 wherein at least a portion of said outside surface of said protective envelope has multiple optically variable indicia imprinted, stamped or engraved thereon.

21. The detectable marker tape of claim 1 wherein at least a portion of said outside surface of said protective envelope has warning indicia imprinted thereon.

22. The detectable marker tape of claim 1 wherein at least a portion of said outside surface of said protective envelope has identification indicia imprinted thereon.

23. The detectable marker tape of claim 1 wherein said protective envelope is formed by an extrusion process.

24. The detectable marker tape of claim 5 wherein said elongated, non-stretchable, core material further comprises a rope-like material.

25. The detectable marker tape of claim 5 wherein said at least one remote locating device comprises tracer wire, said tracer wire extending for substantially the entirety of said third length.
